(19) United States
(12) Patent Application Publication
(10) Pub. No.: US 2018/0091994 A1
(43) Pub. Date: Mar. 29, 2018

(54) TECHNIQUES FOR WLAN MEASUREMENTS FOR UNLICENSED SPECTRUM COMMUNICATIONS

(71) Applicant: QUALCOMM Incorporated, San Diego, CA (US)

(72) Inventors: Ozcan Ozturk, San Diego, CA (US); Arnaud Meylan, San Diego, CA (US); Sivaramakrishna Veerepalli, San Diego, CA (US)

(21) Appl. No.: 15/713,478

(22) Filed: Sep. 22, 2017

Related U.S. Application Data
(60) Provisional application No. 62/399,891, filed on Sep. 26, 2016.

(51) Int. Cl. H04W 24/10; H04W 36/30

(52) U.S. Cl. CPC H04W 24/10; H04W 16/14; H04W 36/30

(57) ABSTRACT

A method and apparatus provide for configuring WLAN measurements for unlicensed spectrum communications. The method and apparatus include receiving, at a network entity, a UE capability message and a reporting message from a UE, determining whether the UE is capable of communicating over the unlicensed spectrum and supports WLAN measurements based on the UE capability message and the reporting message, and transmitting, to the UE, a measurement configuration message including a measurement configuration identifier in accordance with the determination that the UE is capable of communicating over the unlicensed spectrum and supports WLAN measurements. The method and apparatus further include receiving, at a UE, a measurement configuration message and a measurement purpose message from a network entity, determining a measurement configuration of the UE based on the measurement purpose message, and performing one or more measurements for the one or more WLAN access points.

### CLAIM OF PRIORITY UNDER 35 U.S.C. § 119

The present Application for Patent claims priority to U.S. Provisional Application No. 62/399,891 entitled “TECHNIQUES FOR WLAN MEASUREMENTS FOR UNLICENSED SPECTRUM COMMUNICATIONS” filed Sep. 26, 2016, which is assigned to the assignee hereof and hereby expressly incorporated by reference herein.

### BACKGROUND

Aspects of this disclosure relate generally to telecommunications, and more particularly to techniques for configuring Wireless Local Area Network (WLAN) measurements for unlicensed spectrum communications.

A wireless communication network may be deployed to provide various types of services (e.g., voice, data, multimedia services, etc.) to users within a coverage area of the network. In some implementations, one or more access points (e.g., corresponding to different cells) provide wireless connectivity for access terminals (e.g., cell phones) that are operating within the coverage of the access point(s). In some implementations, peer devices provide wireless connectively for communicating with one another.

Some modes of communication may enable communications between a base station and a user equipment (UE) over an unlicensed radio frequency spectrum band, or over different radio frequency spectrum bands (e.g., a licensed radio frequency spectrum band and/or an unlicensed radio frequency spectrum band) of a cellular network. With increasing data traffic in cellular networks that use a licensed radio frequency spectrum band, offloading of at least some data traffic to an unlicensed radio frequency spectrum band may provide a cellular operator with opportunities for enhanced data transmission capacity. An unlicensed radio frequency spectrum band may also provide service in areas where access to a licensed radio frequency spectrum band is unavailable.

In some wireless networks, a UE may perform WLAN measurements for the unlicensed spectrum. For example, a UE performs WLAN measurements and reports them to the network entity (e.g., eNodeB) for assisting in the operation (e.g., enabling/disabling), selection of WLAN network, and handover across multiple WLAN networks. However, WLAN measurements may also be used for unlicensed spectrum communications. The UE capability for the measurements is signalled separately from the UE support of unlicensed spectrum communications, so, in some examples, the UE may be configured to support unlicensed spectrum communications but not Long Term Evolution (LTE) WLAN Aggregation or Interworking.

As such, and given the growing use of the unlicensed spectrum, techniques are needed to provide efficient and improved processes to at least support configuring WLAN measurements for unlicensed spectrum communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a method for configuring WLAN measurements for unlicensed spectrum communications is provided. The described aspects include receiving, at a network entity, a UE capability message and a reporting message from a UE, wherein the UE capability message indicates whether the UE is capable of communicating over an unlicensed spectrum and the reporting message indicates whether the UE supports WLAN measurements. The described aspects further include determining whether the UE is capable of communicating over the unlicensed spectrum and supports WLAN measurements based on the UE capability message and the reporting message. The described aspects further include transmitting, to the UE, a measurement configuration message including a measurement configuration identifier in accordance with the determination that the UE is capable of communicating over the unlicensed spectrum and supports WLAN measurements, wherein the measurement configuration message triggers the UE to perform measurements for one or more WLAN access points based on the measurement configuration identifier.

In an aspect, an apparatus for configuring WLAN measurements for unlicensed spectrum communications may include a transceiver, a memory; and at least one processor coupled to the memory and configured to receive, at a network entity, a UE capability message and a reporting message from a UE, wherein the UE capability message indicates whether the UE is capable of communicating over an unlicensed spectrum and the reporting message indicates whether the UE supports WLAN measurements. The described aspects further determine whether the UE is capable of communicating over the unlicensed spectrum and supports WLAN measurements based on the UE capability message and the reporting message. The described aspects further transmit, to the UE, a measurement configuration message including a measurement configuration identifier in accordance with the determination that the UE is capable of communicating over the unlicensed spectrum and supports WLAN measurements, wherein the measurement configuration message triggers the UE to perform measurements for one or more WLAN access points based on the measurement configuration identifier.

In an aspect, a computer-readable medium may store computer executable code for configuring WLAN measurements for unlicensed spectrum communications is described. The described aspects include code for receiving, at a network entity, a UE capability message and a reporting message from a UE, wherein the UE capability message indicates whether the UE is capable of communicating over an unlicensed spectrum and the reporting message indicates whether the UE supports WLAN measurements. The described aspects further include code for determining whether the UE is capable of communicating over the unlicensed spectrum and supports WLAN measurements based on the UE capability message and the reporting message. The described aspects further include code for transmitting, to the UE, a measurement configuration message including a measurement configuration identifier in accordance with the determination that the UE is capable of communicating over the unlicensed spectrum and supports WLAN measurements, wherein the measurement configuration message triggers the UE to perform measurements for one or more WLAN access points based on the measurement configuration identifier.

In an aspect, an apparatus for configuring WLAN measurements for unlicensed spectrum communications is described. The described aspects include means for receiving, at a network entity, a UE capability message and a reporting message from a UE, wherein the UE capability message indicates whether the UE is capable of communicating over an unlicensed spectrum and the reporting message indicates whether the UE supports WLAN measurements. The described aspects further include means for determining whether the UE is capable of communicating over the unlicensed spectrum and supports WLAN measurements based on the UE capability message and the reporting message. The described aspects further include means for transmitting, to the UE, a measurement configuration message including a measurement configuration identifier in accordance with the determination that the UE is capable of communicating over the unlicensed spectrum and supports WLAN measurements, wherein the measurement configuration message triggers the UE to perform measurements for one or more WLAN access points based on the measurement configuration identifier.

In accordance with another aspect, a method for configuring WLAN measurements for unlicensed spectrum communications is provided. The described aspects include receiving, at a UE, a measurement configuration message and a measurement purpose message from a network entity, wherein the measurement configuration message includes a measurement configuration identifier and triggers the UE to perform measurements for one or more WLAN access points. The described aspects further include determining a measurement configuration of the UE based on the measurement purpose message. The described aspects further include performing one or more measurements for the one or more WLAN access points based on the determination of the measurement configuration of the UE and in accordance with receiving the measurement configuration message.

In an aspect, an apparatus for configuring WLAN measurements for unlicensed spectrum communications may include a transceiver, a memory; and at least one processor coupled to the memory and configured to receive, at a UE, a measurement configuration message and a measurement purpose message from a network entity, wherein the measurement configuration message includes a measurement configuration identifier and triggers the UE to perform measurements for one or more WLAN access points. The described aspects further determine a measurement configuration of the UE based on the measurement purpose message. The described aspects further perform one or more measurements for the one or more WLAN access points based on the determination of the measurement configuration of the UE and in accordance with receiving the measurement configuration message.

In an aspect, a computer-readable medium may store computer executable code for configuring WLAN measurements for unlicensed spectrum communications is described. The described aspects include code for receiving, at a UE, a measurement configuration message and a measurement purpose message from a network entity, wherein the measurement configuration message includes a measurement configuration identifier and triggers the UE to perform measurements for one or more WLAN access points. The described aspects further include code for determining a measurement configuration of the UE based on the measurement purpose message. The described aspects further include code for performing one or more measurements for the one or more WLAN access points based on the determination of the measurement configuration of the UE and in accordance with receiving the measurement configuration message.

In an aspect, an apparatus for configuring WLAN measurements for unlicensed spectrum communications is described. The described aspects include means for receiving, at a UE, a measurement configuration message and a measurement purpose message from a network entity, wherein the measurement configuration message includes a measurement configuration identifier and triggers the UE to perform measurements for one or more WLAN access points. The described aspects further include means for determining a measurement configuration of the UE based on the measurement purpose message. The described aspects further include means for performing one or more measurements for the one or more WLAN access points based on the determination of the measurement configuration of the UE and in accordance with receiving the measurement configuration message.

In accordance with another aspect, a method for configuring WLAN measurements for unlicensed spectrum communications is provided. The described aspects include transmitting, from a UE, a UE capability message and a reporting message to a network entity, wherein the UE capability message indicates whether the UE is capable of communicating over an unlicensed spectrum and the reporting message indicates whether the UE supports WLAN measurements. The described aspects further include receiving a measurement configuration message including a measurement configuration identifier, wherein the measurement configuration message triggers the UE to perform measurements for one or more WLAN access points based on the measurement configuration identifier. The described aspects further include performing one or more measurements for the one or more WLAN access points based on the measurement configuration trigger and in accordance with receiving the measurement configuration message.

In an aspect, an apparatus for configuring WLAN measurements for unlicensed spectrum communications may include a transceiver, a memory; and at least one processor coupled to the memory and configured to transmit, from a UE, a UE capability message and a reporting message to a network entity, wherein the UE capability message indicates whether the UE is capable of communicating over an unlicensed spectrum and the reporting message indicates whether the UE supports WLAN measurements. The described aspects further receive a measurement configuration message including a measurement configuration identifier, wherein the measurement configuration message triggers the UE to perform measurements for one or more WLAN access points based on the measurement configuration identifier. The described aspects further perform one or more measurements for the one or more WLAN access points based on the measurement configuration trigger and in accordance with receiving the measurement configuration message.

In an aspect, a computer-readable medium may store computer executable code for configuring WLAN measurements for unlicensed spectrum communications is described. The described aspects include code for transmitting, from a UE, a UE capability message and a reporting message to a network entity, wherein the UE capability message indicates whether the UE is capable of communicating over an unlicensed spectrum and the reporting message indicates whether the UE supports WLAN measurements. The described aspects further include code for receiving a measurement configuration message including a measurement configuration identifier, wherein the measurement configuration message triggers the UE to perform measurements for one or more WLAN access points based on the measurement configuration identifier. The described aspects further include code for performing one or more measurements for the one or more WLAN access points based on the measurement configuration trigger and in accordance with receiving the measurement configuration message.

In an aspect, an apparatus for configuring WLAN measurements for unlicensed spectrum communications is described. The described aspects include means for transmitting, from a UE, a UE capability message and a reporting message to a network entity, wherein the UE capability message indicates whether the UE is capable of communicating over an unlicensed spectrum and the reporting message indicates whether the UE supports WLAN measurements. The described aspects further include means for receiving a measurement configuration message including a measurement configuration identifier, wherein the measurement configuration message triggers the UE to perform measurements for one or more WLAN access points based on the measurement configuration identifier. The described aspects further include means for performing one or more measurements for the one or more WLAN access points based on the measurement configuration trigger and in accordance with receiving the measurement configuration message.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a second label that distinguishes among the similar components. If the first reference label is used in the specification, the description is applicable to any one of the similar components having the same first reference label irrespective of the second reference label.

FIG. 1 is a block diagram illustrating an exemplary wireless communication system employing one or more entities including co-located radios in accordance with the present aspects.

FIG. 2 is a diagram illustrating an example of an evolved Node B and user equipment in an access network according to the present aspects.

FIG. 3A illustrates an exemplary downlink frame structure used in LTE in accordance with the present aspects.

FIG. 3B is a diagram illustrating another exemplary downlink frame structure used in LTE according to the present aspects.

FIG. 4A and 4B are schematic diagrams illustrating an example of a communication network including an aspect of configuring WLAN measurements for unlicensed spectrum communications.

FIG. 5 is a flow diagram illustrating an exemplary method of configuring WLAN measurements for unlicensed spectrum communications in accordance with the present aspects.

FIG. 6 is a flow diagram illustrating a second exemplary method of configuring WLAN measurements for unlicensed spectrum communications in accordance with the present aspects.

FIG. 7 is a flow diagram illustrating a third exemplary method of configuring WLAN measurements for unlicensed spectrum communications in accordance with the present aspects.

FIG. 8 is a simplified diagram of an exemplary wireless communication system in accordance with the present aspects.

FIG. 9 is a simplified block diagram of exemplary components that may be employed in communication nodes in accordance with the present aspects.

FIG. 10 is a conceptual data flow diagram illustrating the data flow between different means/components in an exemplary apparatus including a measurement component in accordance with the present aspects.

FIG. 11 is a diagram illustrating an example of a hardware implementation for an apparatus employing a processing system including a measurement component in accordance with the present aspects.

FIG. 12 is a conceptual data flow diagram illustrating the data flow between different means/components in an exemplary apparatus including a measurement configuration component in accordance with the present aspects.

FIG. 13 is a diagram illustrating an example of a hardware implementation for an apparatus employing a processing system including a measurement configuration component in accordance with the present aspects.

An Appendix is included that is part of the present application and provides additional details related to the various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

The present aspects generally relate to the harmonization or convergence of different features supported by cellular communications over unlicensed or shared spectrum. These cellular communications may sometimes be referred to as, for example, LTE over unlicensed spectrum, LTE-U, license-assisted access (LAA), MulteFire, and fifth generation (5G) New Radio (NR) communications. The use of unlicensed band or spectrum operation opens the opportunity of using a larger number of carriers (e.g., component carriers or CCs). Unlicensed band or spectrum may sometimes be referred to as shared band or spectrum. The use of a large number of carriers is in contrast to conventional carrier aggregation (CA) operations in which the number of CCs supported is much smaller, and consequently, may not scale well from the perspective of UE power consumption. To take advantage of the power savings opportunities provided by unlicensed band operation, different modifications to the way cellular communications operate over unlicensed or shared spectrum are described herein. Some of these modifications are intended to, at least in part, configure WLAN measurements for unlicensed spectrum communications.

As described above, current operations may not be optimized for more than a few carriers, and therefore, may not be able to handle the large number of carriers available for unlicensed band or spectrum operation, let alone handle different types of carriers (e.g., carriers over a licensed spectrum or licensed carriers, carriers over an unlicensed spectrum or unlicensed carriers). One area where this may be an issue is with WLAN measurement configuration for the unlicensed spectrum. For example, a UE performs WLAN measurements and reports them to the network entity (e.g., eNodeB) for assisting in the operation (e.g., enabling/disabling), selection of WLAN network, and handover across multiple WLAN networks. However, WLAN measurements may also be used for unlicensed spectrum communications (e.g., LAA, LTE-U, etc.). The UE capability for the measurements is signalled separately from the UE's support of unlicensed spectrum communications, so, in some examples, the UE may be configured to support unlicensed spectrum communications but not LTE WLAN Aggregation or Interworking (e.g., LWA, LWIP, and RCLWI).

Nonetheless, a number of issues exist with regard to configuring WLAN measurements for unlicensed spectrum communications. One issue is that a network entity needs to provide the identifiers for each of the access points that the UE performs measurements for. In instances of LTE WLAN Aggregation or Interworking, the UE only measures and reports the access points that are configured for LTE WLAN Aggregation or Interworking. However, for unlicensed spectrum communications, there may be access points not known to the network entity (e.g., hidden access points), but are still configured to communicate on the unlicensed spectrum (e.g., LAA communications). As such, the network entity needs a mechanism in order to enable the network entity to communicate to the UE to perform measurements with one or more access points not necessarily known to the network entity and/or specifically indicated by an identifier transmitted with a measurement configuration message.

Another issue is that a network entity needs to be able to transmit an indication regarding the purpose of the measurements. For example, the network entity may need to indicate that the measurements are for either LTE WLAN Aggregation or Interworking or unlicensed spectrum communications. In an example, measurements for LTE WLAN Aggregation or Interworking may result in LTE WLAN Aggregation or Interworking configuration even though this may not be acceptable for the user preference of the UE even though unlicensed spectrum communications is desired. For instance, if a UE is already connected to a user deployed access point, LTE WLAN Aggregation or Interworking is not possible since the UE is already in use. However, in this instance, WLAN measurements for unlicensed spectrum communications (e.g., LAA channel selection) may be acceptable, so that the network entity may use the measurements to select the least occupied WLAN channel.

Accordingly, in some aspects, the present methods and apparatuses may provide an efficient solution, as compared to conventional solutions, by configuring WLAN measurements for unlicensed spectrum communications. In other words, in the present aspects, a UE and/or network entity may efficiently and effectively configure the measurements that a UE performs with one or more access points. As such, the present aspects provide one or more mechanisms for receiving, at a network entity, a UE capability message and a reporting message from a UE, wherein the UE capability message indicates whether the UE is capable of communicating over an unlicensed spectrum and the reporting message indicates whether the UE supports WLAN measurements. The present aspects provide one or more mechanisms for determining whether the UE is capable of communicating over the unlicensed spectrum and supports WLAN measurements based on the UE capability message and the reporting message. The present aspects provide one or more mechanisms for transmitting, to the UE, a measurement configuration message including a measurement configuration identifier in accordance with the determination that the UE is capable of communicating over the unlicensed spectrum and supports WLAN measurements, wherein the measurement configuration message triggers the UE to perform measurements for one or more access points based on the measurement configuration identifier.

Aspects of the disclosure are provided in the following description and related drawings directed to specific disclosed aspects. Alternate aspects may be devised without departing from the scope of the disclosure. Additionally, well-known aspects of the disclosure may not be described in detail or may be omitted so as not to obscure more relevant details. Further, many aspects are described in terms of sequences of actions to be performed by, for example, elements of a computing device. It will be recognized that various actions described herein can be performed by specific circuits (e.g., application-specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

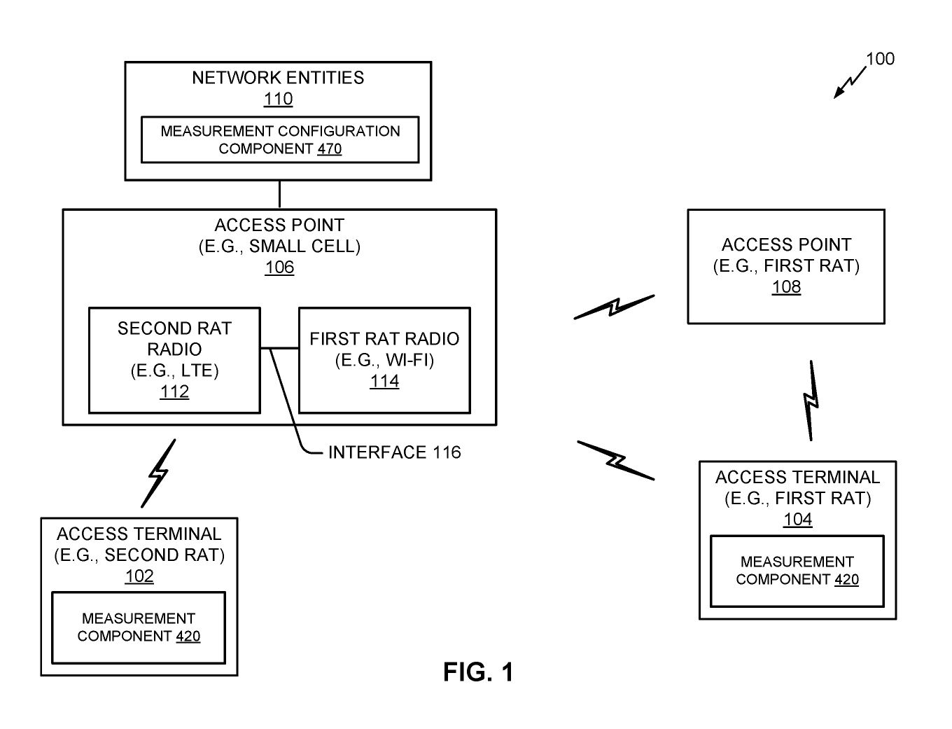

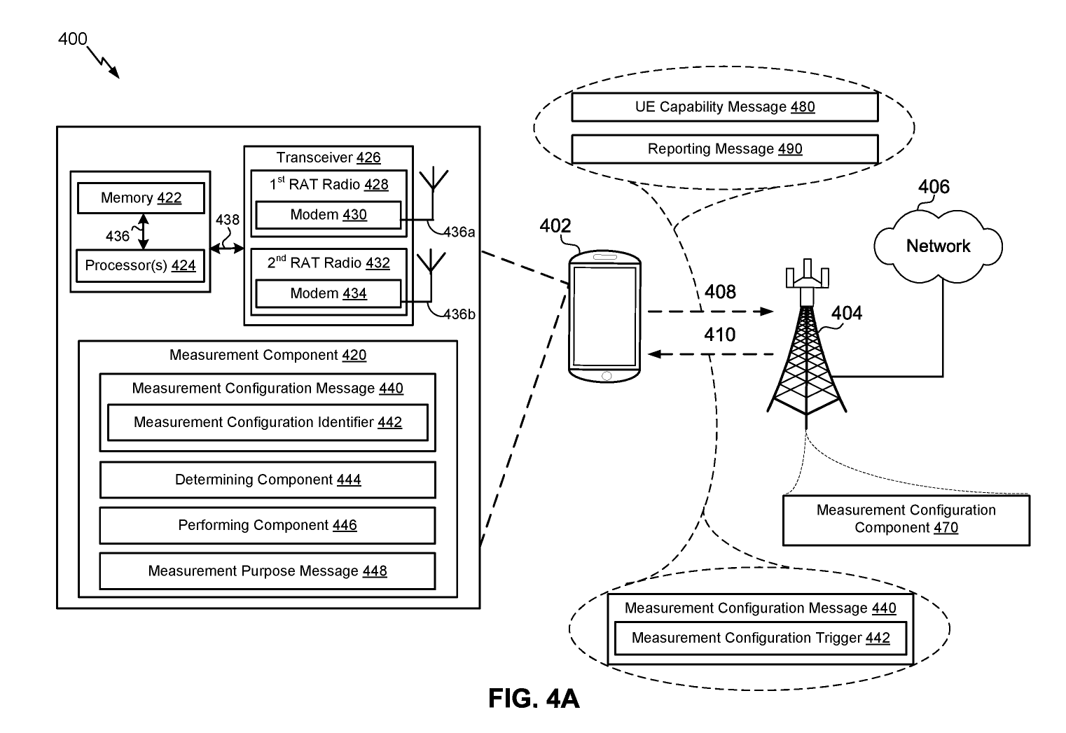

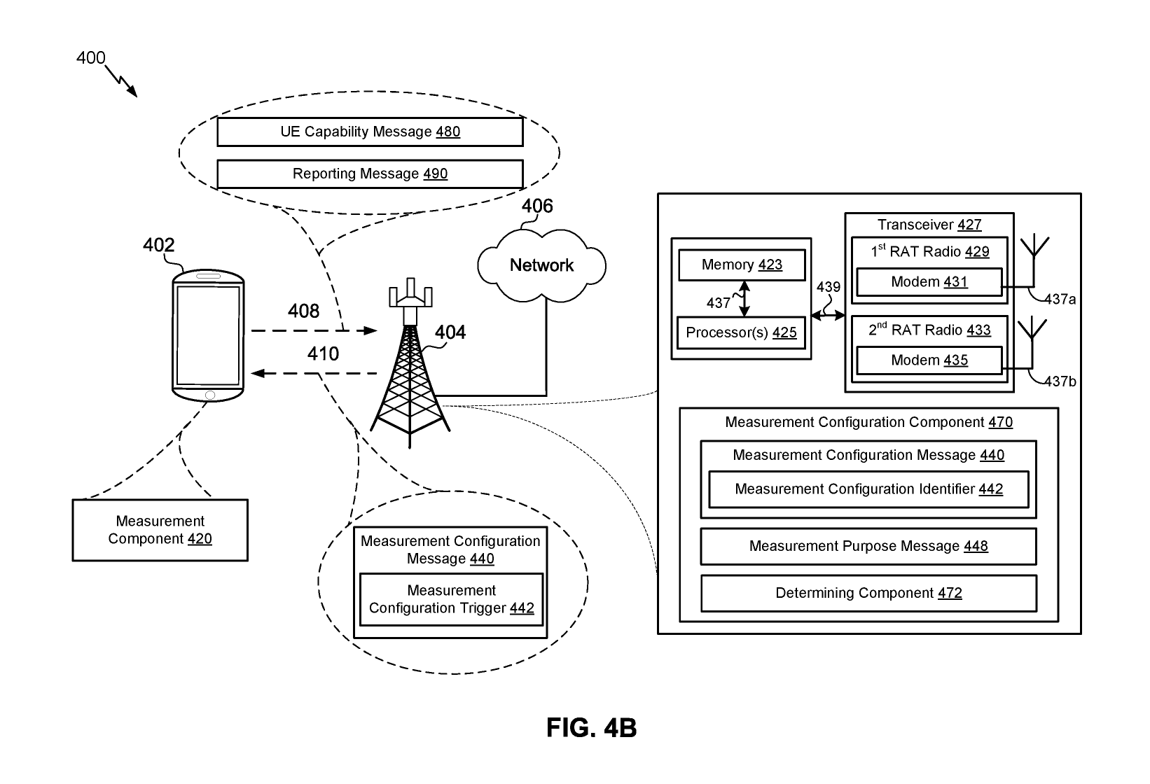

FIG. 1 illustrates several nodes of an example wireless communication system 100 (e.g., a portion of a communications network). An access terminal (e.g., access terminal 102, 104) may include a measurement component 420 (FIG. 4A) and one or more network entities 110 may include a corresponding measurement configuration component 470 (FIG. 4B). The respective components are configured to operate to configure WLAN measurements for unlicensed spectrum communications.

For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, Home NodeBs, Home eNodeBs, small cells, macro cells, femto cells, and so on, while access terminals may be referred to or implemented as user equipment (UEs), mobile stations, and so on.

Access points 106, 108 may provide access to one or more services (e.g., network connectivity) for one or more wireless terminals (e.g., access terminal 102, 104) that may be installed within or that may roam throughout a coverage area of system 100. For example, at various times, access terminal 102 may communicate to the access point 106 or some other access point in system 100. Similarly, access terminal 104 may communicate to access point 108 or some other access point. One or more of access points 106, 108 may communicate with one or more network entities (represented, for convenience, by network entities 110), which may correspond to network entity 404 (FIG. 4B) including measurement configuration component 470 (FIG. 4B) in the system 400, including each other, to facilitate wide-area network (WAN) connectivity. Two or more of such network entities may be co-located and/or two or more of such network entities may be distributed throughout a network.

A network entity may take various forms such as, for example, one or more radio and/or core network entities. Thus, in various implementations, network entities 110 may represent functionality such as at least one of: network management (e.g., via an operation, administration, management, and provisioning entity), call control, session management, mobility management, gateway functions, interworking functions, or some other suitable network functionality. In some aspects, mobility management relates to: keeping track of the current location of access terminals through the use of tracking areas, location areas, routing areas, or some other suitable technique; controlling paging for access terminals; and providing access control for access terminals.

When access point 106 (or any other devices in system 100) uses a first radio access technology (RAT) to communicate on a given resource, this communication may be subjected to interference from nearby devices (e.g., access point 108 and/or access terminal 104) that use a second RAT to communicate on that resource. For example, communication by the access point 106 via LTE on a particular unlicensed RF band (e.g., 5 GHz) may be subject to interference from Wi-Fi devices operating on that band. For convenience, LTE on an unlicensed RF band may be referred to herein as LTE/LTE Advanced in unlicensed spectrum, or simply LTE in the surrounding context. Moreover, a network or device that provides, adapts, or extends LTE/LTE Advanced in unlicensed spectrum may refer to a network or device that is configured to operate in a contention-based radio frequency band or spectrum.

In some systems, LTE in unlicensed spectrum may be employed in a standalone configuration, with all carriers operating exclusively in an unlicensed portion of the wireless spectrum (e.g., LTE Standalone). In other systems, LTE in unlicensed spectrum may be employed in a manner that is supplemental to licensed band operation by providing one or more unlicensed carriers operating in the unlicensed portion of the wireless spectrum in conjunction with an anchor licensed carrier operating in the licensed portion of the wireless spectrum (e.g., LTE Supplemental DownLink (SDL) or licensed-assisted access (LAA)). In either case, carrier aggregation (CA) may be employed to manage the different component carriers, with one carrier serving as the Primary Cell (PCell) for the corresponding UE (e.g., an anchor licensed carrier in LTE SDL or a designated one of the unlicensed carriers in LTE Standalone) and the remaining carriers serving as respective Secondary Cells (SCells). In this way, the PCell may provide an FDD paired downlink and uplink (licensed or unlicensed), and each SCell may provide additional downlink capacity as desired.

In general, LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

The disclosure relates in some aspects to techniques referred to herein as carrier sense adaptive transmission (CSAT), which may be used to facilitate co-existence between different technologies operating on a commonly used resource (e.g., a particular unlicensed RF band or co-channel). The access point 106 includes co-located radios (e.g., transceivers) 112 and 114. The radio 112 uses a second RAT (e.g., LTE) to communicate. The radio 114 is capable of receiving signals using a first RAT (e.g., Wi-Fi). In addition, an interface 116 enables the radios 112 and 114 to communicate with one another. In another aspect, the radio 114 may communicate using a second RAT (e.g., LTE in unlicensed spectrum) that is related to the first RAT (e.g., LTE in licensed spectrum). Radios 112, 114 may share physical-layer transmission information, such as the location of a discovery reference signal (DRS). Accordingly, the second radio 112 may transmit a DRS in a secondary component carrier while the first radio 114 sends an indication of the placement of the DRS on a primary component carrier.

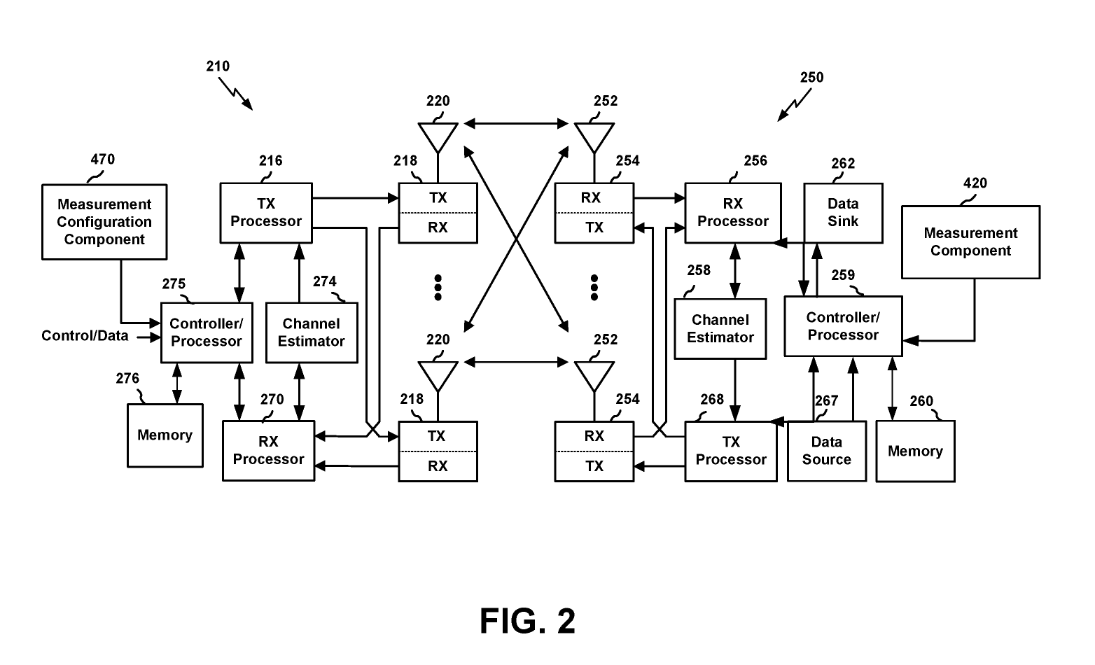

FIG. 2 is a block diagram of a base station 210 in communication with a UE 250 in an access network. In the DL, upper layer packets from the core network are provided to a controller/processor 275. The controller/processor 275 implements the functionality of the L2 layer. In the DL, the controller/processor 275 provides header compression, ciphering, packet segmentation and reordering, multiplexing between logical and transport channels, and radio resource allocations to the UE 250 based on various priority metrics. The controller/processor 275 is also responsible for HARQ operations, retransmission of lost packets, and signaling to the UE 250.

The transmit (TX) processor 216 implements various signal processing functions for the

L1 layer (i.e., physical layer). The signal processing functions includes coding and interleaving to facilitate forward error correction (FEC) at the UE 250 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream is then provided to a different antenna 220 via a separate transmitter 218TX. Each transmitter 318TX modulates an RF carrier with a respective spatial stream for transmission.

In addition, base station 210 may include measurement configuration component 470 (FIG. 4B) configured to transmit one or more transmissions including a discovery reference signal over an unlicensed radio frequency spectrum to a UE. Though measurement configuration component 470 is shown as coupled to controller/processor 275, it is to be appreciated that measurement configuration component 470 can also be coupled to other processors (e.g., RX processor 270, TX processor 216, etc.) and/or implemented by the one or more processors 216, 270, 275 to perform actions described herein. Furthermore, for example, measurement configuration component 470 may be implemented by any one or more of the processors including, but not limited to, processors 216, 270, and/or 275. Similarly, measurement configuration component 470 may be implemented by any one or more of the processors including, but not limited to, processors 256, 259, and/or 268.

At the UE 250, each receiver 254RX receives a signal through its respective antenna 252.

Each receiver 254RX recovers information modulated onto an RF carrier and provides the information to the receive (RX) processor 256. The RX processor 256 implements various signal processing functions of the L1 layer. The RX processor 256 performs spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259.

The controller/processor 259 implements the L2 layer. The controller/processor can be associated with a memory 260 that stores program codes and data. The memory 260 may be referred to as a computer-readable medium. In the UL, the controller/processor 259 provides demultiplexing between transport and logical channels, packet reassembly, deciphering, header decompression, control signal processing to recover upper layer packets from the core network. The upper layer packets are then provided to a data sink 262, which represents all the protocol layers above the L2 layer. Various control signals may also be provided to the data sink 262 for L3 processing. The controller/processor 259 is also responsible for error detection using an acknowledgement (ACK) and/or negative acknowledgement (NACK) protocol to support HARQ operations. In addition, UE 250 may include a measurement component 420 (see e.g., FIG. 4A) configured to monitor for the one or more discovery reference signals. Though measurement component 420 is shown as coupled to controller/processor 259, it is to be appreciated that measurement component 420 can also be coupled to other processors (e.g., RX processor 256, TX processor 268, etc.) and/or implemented by the one or more processors 256, 259, 268 to perform actions described herein.

In the UL, a data source 267 is used to provide upper layer packets to the controller/processor 259. The data source 267 represents all protocol layers above the L2 layer. Similar to the functionality described in connection with the DL transmission by the base station 210, the controller/processor 259 implements the L2 layer for the user plane and the control plane by providing header compression, ciphering, packet segmentation and reordering, and multiplexing between logical and transport channels based on radio resource allocations by the base station 210. The controller/processor 259 is also responsible for HARQ operations, retransmission of lost packets, and signaling to the base station 210.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 368 are provided to different antenna 252 via separate transmitters 254TX. Each transmitter 254TX modulates an RF carrier with a respective spatial stream for transmission.

The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270. The RX processor 270 may implement the L1 layer.

The controller/processor 275 implements the L2 layer. The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover upper layer packets from the UE 250. Upper layer packets from the controller/processor 275 may be provided to the core network. The controller/processor 275 is also responsible for error detection using an ACK and/or NACK protocol to support HARQ operations.

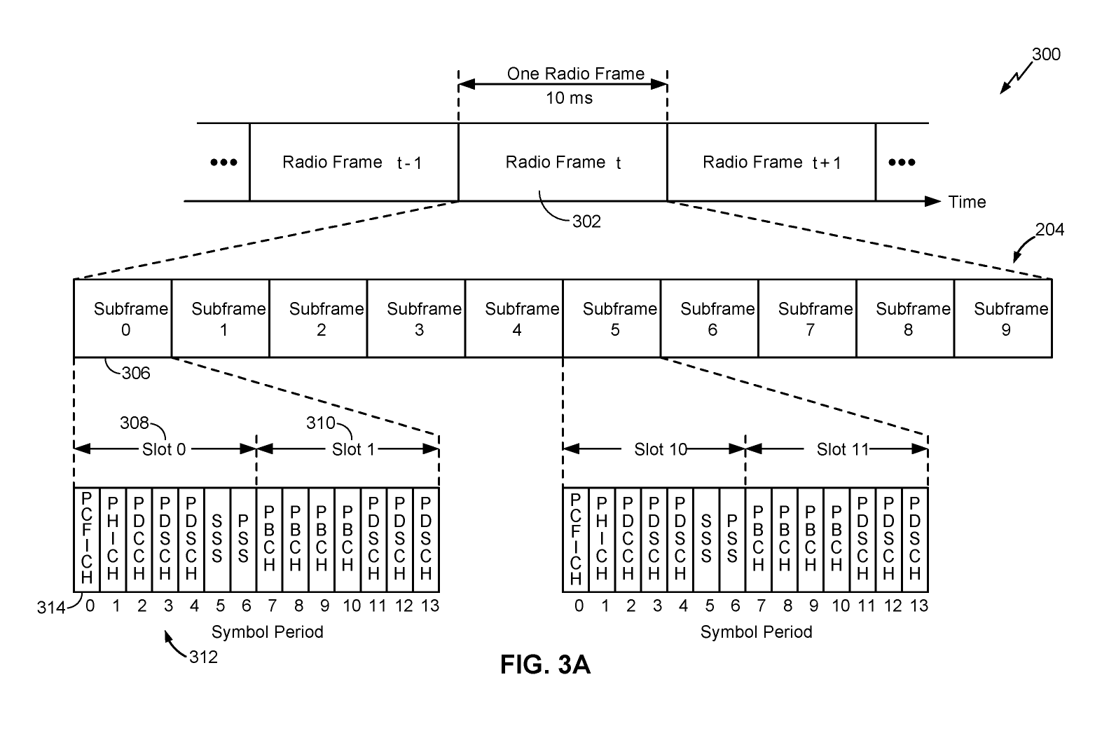

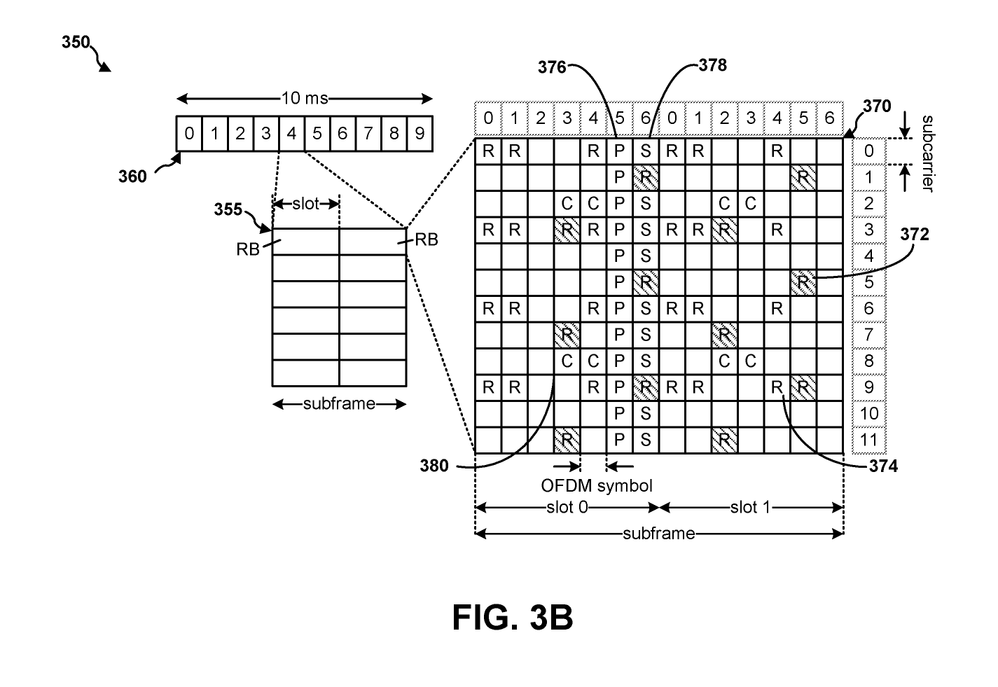

FIG. 3A shows a downlink frame structure 300 used in LTE, which may be used in sending communications from measurement configuration component 470 (FIG. 4B) to measurement component 420 (FIG. 4A). The transmission timeline for the downlink may be partitioned into units of radio frames 302, 304. Each radio frame 302 may have a predetermined duration (e.g., 10 milliseconds (ms)) and may be partitioned into 10 subframes 306 with indices of 0 through 9. Each subframe may include two slots, e.g., slots 308, 310. Each radio frame 302, 304 may thus include 20 slots with indices of 0 through 19. Each slot may include L symbol periods, e.g., 7 symbol periods 212 for a normal cyclic prefix (CP), as shown in FIG. 3A, or 6 symbol periods for an extended cyclic prefix. The normal CP and extended CP may be referred to herein as different CP types. The 2L symbol periods in each subframe may be assigned indices of 0 through 2L-1. The available time frequency resources may be partitioned into resource blocks. Each resource block may cover N subcarriers (e.g., 12 subcarriers) in one slot.

In LTE, the access point (referred to as an evolved node B (eNB)), which may correspond to network entity 404 including measurement configuration component 470 (FIG. 4B), may transmit a discovery reference signal (DRS). The DRS may include a Primary Synchronization Signal (PSS) and a Secondary Synchronization Signal (SSS), which may be unique for each cell. In an aspect, for example, the primary and secondary synchronization signals may be transmitted in symbol periods 6 and 5, respectively, in each subframe that includes a DRS. For example, as shown in FIG. 3A, subframes 0 and 5 with the normal cyclic prefix may include at least some physical reference signals of the DRS (e.g., the synchronization signals, PSS and SSS). The synchronization signals may be used by the access terminals (referred to as UEs) for cell detection and acquisition. For example, a UE may use the synchronization signals as part of measurements during a cell detection and/or cell selection process. The eNB may also send a cell-specific reference signal (CRS). For example, the CRS may be sent in symbols 0, 1, and 4 of each slot in case of the normal cyclic prefix, and in symbols 0, 1, and 3 of each slot in case of the extended cyclic prefix. The CRS may be used by UEs for coherent demodulation of physical channels, timing and frequency tracking, Radio Link Monitoring (RLM), Reference Signal Received Power (RSRP), and Reference Signal Received Quality (RSRQ) measurements, etc.

The eNB may also send other signals, such as a Physical Broadcast Channel (PBCH) in symbol periods 0 to 3 in slot 1 of subframe 0, and a Physical Control Format Indicator Channel (PCFICH). In an aspect, the eNB may send the PCFICH in only a portion of the first symbol period of each subframe, although depicted in the entire first symbol period in FIG. 3A. The eNB may also send a Physical HARQ Indicator Channel (PHICH) and a Physical Downlink Control Channel (PDCCH) in the first M symbol periods of each subframe (M=3 in FIG. 3A). The eNB may also send a Physical Downlink Shared Channel (PDSCH) in the remaining symbol periods of each subframe. The various signals and channels in LTE are described in 3GPP TS 36.211, entitled “Evolved Universal Terrestrial Radio Access (E-UTRA); Physical Channels and Modulation,” which is publicly available and incorporated by reference in its entirety. Further, 3GPP publications 3GPP TS 36.212, 36.213, and 36.331 are also publicly available and incorporated by reference in their entireties.

In an aspect, the eNB may send the PSS, SSS and PBCH in the center 1.08 MHz of the system bandwidth used by the eNB. In an aspect, the bandwidth used to transmit the PSS, SSS, and/or PBCH may be expanded to use up to the entire system bandwidth. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search (e.g., the common search space or the UE-specific search space). A UE may be within the coverage of multiple eNBs. One of these eNBs may be selected to serve the UE, and may also be referred to as the primary cell (Pcell). The serving eNB may be selected based on various criteria such as received power, path loss, signal-to-noise ratio (SNR), etc.

FIG. 3B is a diagram 350 illustrating another example of a downlink (DL) frame structure 360 in LTE. A frame (10 ms) may be divided into 10 equally sized subframes 365. Each subframe 365 may include two consecutive time slots. A resource grid 370 may be used to represent two time slots, each time slot including a resource block. The resource grid 370 is divided into multiple resource elements (REs). Some of the resource elements, indicated as R 372, 374, include DL reference signals (DL-RS). The DL-RS may include cell-specific RS (CRS) (also sometimes called common RS) 372 and UE-specific RS (UE-RS) 374. UE-RS 374 is transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In subframes where the DRS is transmitted, the resource grid 370 may also include resource elements for the DRS. For example, the resource grid 370 may include resource elements for a PSS (P) 376, SSS (S) 378, and CSI-RS (C) 380. In an aspect, the elements for transmitting the DRS may be unavailable for transmitting a transport block for the UE on the PDSCH. Accordingly, the transport block may be rate-matched around the DRS, as well as the DL-RS. In an aspect, an eNB may signal which subframes include the DRS so the UE can appropriately rate match the received transmission in those subframes. In an aspect, the enhanced system information block (eSIB) may be transmitted on the PDSCH by rate-matching the eSIB around resource elements of the DRS such as the CSI-RS.

FIGS. 4A and 4B are block diagrams conceptually illustrating an example of a wireless communication system 400 in accordance with an aspect of the present disclosure, wherein respective components operate to configure WLAN measurements for unlicensed spectrum communications. Wireless communication system 400 may include one or more network entities 404, for example, one or more evolved NodeBs (eNodeBs) communicating with one or more UEs, such as UE 402, via one or more communication channels 408 and/or 410. The one or more network entities 404 may be connected to network 406 and provide access for network 406 to one or more UEs, such as UE 402.

In an aspect, each network entity 404 may be an example of access point 106 (FIG. 1), and UE 402 may be an example of access terminal 102 (FIG. 1). Each network entity 404 may include measurement configuration component 470, which may be configured to transmit one or more measurement configuration messages 440 to a UE, such as UE 402. The UE 402 may be configured with measurement component 420 to perform measurements with one or more access points based on a measurement configuration message 440.

In some aspect, the UE 402 may include memory 422, one or more processors 424 and a transceiver 426. The memory 422, one or more processors 424 and the transceiver 426 may communicate internally via a bus 436. In some examples, the memory 422 and the one or more processors 424 may be part of the same hardware component (e.g., may be part of a same board, module, or integrated circuit). Alternatively, the memory 422 and the one or more processors 424 may be separate components that may act in conjunction with one another. In some aspects, the bus 438 may be a communication system that transfers data between multiple components and subcomponents of the UE 402. In some examples, the one or more processors 424 may include any one or combination of modem processor, baseband processor, digital signal processor and/or transmit processor. Additionally or alternatively, the one or more processors 424 may include a measurement component 420 for carrying out one or more methods or procedures described herein. The measurement configuration component 420 may comprise hardware, firmware, and/or software and may be configured to execute code or perform instructions stored in a memory (e.g., a computer-readable storage medium).

In some examples, the UE 402 may include the memory 422, such as for storing data used herein and/or local versions of applications or communication with the measurement configuration component 420 and/or one or more of the subcomponents of the measurement configuration component 420 being executed by the one or more processors 424. The memory 422 can include any type of computer-readable medium usable by a computer or the one or more processors 424, such as random access memory (RAM), read only memory (ROM), tapes, magnetic discs, optical discs, volatile memory, non-volatile memory, and any combination thereof. In an aspect, for example, the memory 422 may be a computer-readable storage medium (e.g., a non-transitory medium) that stores one or more computer-executable codes defining the measurement configuration component 420 and/or one or more of its subcomponents, and/or data associated therewith, when the UE 402 is operating the one or more processors 424 to execute measurement configuration component 420 and/or one or more of subcomponents of the measurement configuration component 420.

In some examples, the UE 402 may further include a transceiver 426 for transmitting and/or receiving one or more data and control signals to/from the network via the one or more network entities 404. The transceiver 426 may comprise hardware, firmware, and/or software and may be configured to execute code or perform instructions stored in a memory (e.g., a computer-readable storage medium). The transceiver 426 may include a 1st RAT radio 428 comprising a modem 430, and a 2nd RAT radio 432 (e.g., LTE radio) comprising a modem 434. The 1st RAT radio 428 and 2nd RAT radio 432 may utilize one or more antennas 436a-b for transmitting signals to and receiving signals from the one or more network entities 404. In an example, 1st RAT radio 428 may be associated with a wireless local area network (WLAN) and 2nd RAT radio 432 may be associated with a wireless wide area network (WWAN) over unlicensed spectrum.

Similarly, with regard to FIG. 4B, network entity 404 may include a memory 423, one or more processors 425 and a transceiver 427. Memory 423, one or more processors 425 and a transceiver 427 may operate in the same and/or similar manner to memory 422, one or more processors 424 and a transceiver 426 of UE 402 described in FIG. 4A. Furthermore, memory 423, one or more processors 425 and a transceiver 427 may operate the same and/or similar components including, but not limited to a Pt RAT radio 429 with a modem 431, a 2^{nd} RAT radio 433 with a modem 435, and antennas 437a-b. Moreover, memory 423, one or more processors 425 and the transceiver 427 may communicate internally via buses 437 and 439.

Referring back to FIG. 4A, UE 402 and/or measurement component 420 may be configured to perform WLAN measurements for unlicensed spectrum communications. In an aspect, the UE 402 and/or measurement component 420 may execute transceiver 426 to transmit a UE capability message 480 and a reporting message 490 to a network entity 404 via communications channel 408, wherein the UE capability message 480 indicates whether the UE 402 is capable of communicating over an unlicensed spectrum and the reporting message 490 indicates whether the UE 402 supports WLAN measurements. In another aspect, the UE 402 and/or measurement component 420 may execute transceiver 426 to receive a measurement configuration message 440 and/or a measurement purpose message 448 transmitted from network entity 404 via communications channel 410. For example, the measurement configuration message 440 includes a measurement configuration identifier 442 and may trigger the UE 402 to perform measurements for one or more access points based on the measurement configuration identifier 442. In another example, the measurement purpose message 448 may be transmitted by network entity 404 either separately from the measurement configuration message 440 or with the measurement configuration message 440. For example, the measurement purpose message 448 may be transmitted as a flag within the measurement configuration message 440 and/or within the measurement configuration identifier 442.

In an aspect, UE 402 and/or measurement component 420 may include a determining component 444, which may be configured to determine a measurement configuration of UE 402 based on the measurement purpose message 448. In an example, the determining component 444 may determine that the one or more measurements correspond to one or more LTE WLAN Aggregation or Interworking measurements and determine that a Wi-Fi radio of the UE 402 is engaged. In a further example, the determining component 444 may determine that the one or more measurements are not to be used for LTE WLAN Aggregation or Interworking or correspond to one or more unlicensed cellular operations and determine that a Wi-Fi radio of the UE 402 is engaged. In another example, the determining component 444 may determine that the one or more measurements correspond to one or more LTE WLAN Aggregation or Interworking measurements and determine that one or more resources required for performing the LWA measurements is engaged for unlicensed spectrum communications.

In an aspect, the UE 402 and/or measurement component 420 may include a performing component 446, which may be configured to perform one or more measurements for the one or more access points based on the determination of the measurement configuration of the UE 402 and in accordance with receiving the measurement configuration message 440. In an example, the performing component 446 may forego performance of WLAN measurements for the one or more WLAN access points based on the determination that the one or more measurements correspond to the one or more LTE WLAN Aggregation or Interworking measurements and that the Wi-Fi radio of the UE is engaged. In a further example, the performing component 446 may perform one or more WLAN measurements for the one or more access points based on the determination that the one or more measurements are not to be used for LTE WLAN Aggregation or Interworking or correspond to the one or more unlicensed cellular measurements and that the Wi-Fi radio of the UE 402 is engaged. In another aspect, the performing component 446 may perform one or more measurements for the one or more access points based on the measurement configuration identifier 442 and in accordance with receiving the measurement configuration message 440.

In an example, the measurement configuration message 440 triggers the UE 402 to perform measurements for all access points within a geographic area of the UE 402 based on the measurement configuration identifier 442. In some examples, this may include one or more access points that may be unknown and/or hidden to network entity 404. In another example, the measurement configuration message 440 triggers the UE 402 to perform measurements for a subset of access points of the one or more access points within a geographic area of the UE 402 based on the measurement configuration identifier 442. In an instance, the measurement configuration identifier 442 may indicate that only a subset of access points corresponding to a specific service operator. In a further example, the measurement configuration message 440 triggers the UE 402 to perform measurements for the one or more access points over the unlicensed spectrum based on the measurement configuration identifier 442. In an instance, the measurement configuration identifier 442 may indicate that the measurements are for at least one of LAA, LTE-U, MulteFire, or 5G communications. In another example, the measurement configuration message 440 may trigger the UE 402 to perform WLAN measurements for the one or more access points. In another aspect, the measurement configuration message 440 may trigger the UE 402 to perform measurements for the one or more access points without including the measurement configuration identifier 442.

In an aspect, the measurement configuration identifier 442 may correspond to at least one of a SSID, BSSID, or HESSID. For example, the SSID uses ASCII encoding to trigger UE 402 to perform measurements for the one or more access points. In an instance, a measurement configuration component 470 may configure the measurement configuration identifier 442 to a specific SSID, such as, but not limited to, a thirty two (32) byte character of “*.” In another example, the BSSID uses at least one of an unassigned MAC address, a MAC address of the UE 402, or a combination there of to trigger UE 402 to perform measurements for the one or more access points. In an instance, the measurement configuration component 470 may configure measurement configuration identifier 442 with at least one of a SSID, BSSID, or HESSID in order to indicate that the measurements are for unlicensed spectrum communications.

Referring to FIG. 4B, the network entity 404 and/or measurement configuration component 470 may configure a UE, such as UE 402, to perform WLAN measurements for unlicensed spectrum communications. In an aspect, the network entity 404 and/or measurement configuration component 470 may execute the transceiver 427 to receive a UE capability message 480 and a reporting message 490 from a UE 402. For example, the UE capability message 480 indicates whether the UE 402 is capable of communicating over an unlicensed spectrum and the reporting message 490 indicates whether the UE 402 supports WLAN measurements. In an example, the UE capability message 480 may indicate that UE 402 specifically supports LAA communications.

In an aspect, the network entity 404 and/or measurement configuration component 470 may include a determining component 472, which may be configured to determine whether the UE 402 is capable of communicating over the unlicensed spectrum and supports WLAN measurements based on the UE capability message 480 and the reporting message 490. For example, the UE capability message 480 may indicate that the UE 402 supports a specific type of communications over the unlicensed spectrum, such as LAA communications. Moreover, the reporting message 490 may indicate that the UE 402 is configured to perform WLAN measurements with any access points within a geographic area of UE 402. As such, the measurement configuration component 470 may generate a measurement configuration message 440 based on the determination of whether the UE 402 is capable of communicating over the unlicensed spectrum and supports WLAN measurements.

In an aspect, the network entity 404 and/or measurement configuration component 470 may execute transceiver 427 to transmit, to the UE 402, a measurement configuration message 440 including a measurement configuration identifier 442 in accordance with the determination that UE 402 is capable of communicating over the unlicensed spectrum and supports WLAN measurements. For example, if the measurement configuration component 470 makes a determination that the UE 402 is capable of communicating over the unlicensed spectrum and supports WLAN measurements, then the network entity 404 may transmit a measurement configuration message 440 that triggers the UE 402 to perform measurements with one or more access points for unlicensed spectrum communication, and not only, for example, access points with identifiers known to the network entity 404. As such, the measurement configuration component 470 may generate the measurement configuration message 440 to include a measurement configuration identifier 442, and the measurement configuration message 440 triggers the UE 402 to perform measurements for one or more access points based on the measurement configuration identifier 442.

In an example, the measurement configuration message 440 triggers the UE 402 to perform measurements for all access points within a geographic area of the UE 402 based on the measurement configuration identifier 442. In some examples, this may include one or more access points that may be unknown and/or hidden to the network entity 404. In another example, the measurement configuration message 440 triggers the UE 402 to perform measurements for a subset of access points of the one or more access points within a geographic area of the UE 402 based on the measurement configuration identifier 442. In an instance, the measurement configuration identifier 442 may indicate that only a subset of access points corresponding to a specific service operator. In a further example, the measurement configuration message 440 triggers the UE 402 to perform measurements for the one or more access points over the unlicensed spectrum based on the measurement configuration identifier 442. In an instance, the measurement configuration identifier 442 may indicate that the measurements are for at least one of LAA, LTE-U, Multi-Fire, or 5G communications. In another example, the measurement configuration message 440 may trigger the UE 402 to perform WLAN measurements for the one or more access points. In another aspect, the measurement configuration message 440 may trigger the UE 402 to perform measurements for the one or more access points without including the measurement configuration identifier 442.

In an aspect, the measurement configuration identifier 442 may correspond to at least one of a SSID, BSSID, or HESSID. For example, the SSID uses ASCII encoding to trigger UE 402 to perform measurements for the one or more access points. In an instance, the measurement configuration component 470 may configure the measurement configuration identifier 442 to a specific SSID, such as, but not limited to, a thirty two (32) byte character of “*.” In another example, the BSSID uses at least one of an unassigned MAC address, a MAC address of UE 402, or a combination there of to trigger the UE 402 to perform measurements for the one or more access points. In an instance, the measurement configuration component 470 may configure the measurement configuration identifier 442 with at least one of a SSID, BSSID, or HESSID in order to indicate that the measurements are for unlicensed spectrum communications.

In an aspect, the network entity 404 and/or measurement configuration component 470 may execute the transceiver 427 to transmit to the UE 402, a measurement purpose message 448 indicating that the measurement configuration message 440 corresponds to disabling LTE WLAN Aggregation or Interworking. For example, the measurement purpose message 448 may be transmitted to the UE 402 separately from the measurement configuration message 440. Moreover, the measurement purpose message 448 may indicate that the measurements are for at least one of LAA, LTE-U, Multi-Fire, or 5G communications. Further, the measurement purpose message 448 may indicate whether the measurements are intended to control a connection of UE 402 to a WLAN (e.g., LWA, LWIP, or RCLWI) or to assist the network entity 404. In another example, the measurement purpose message 448 may be transmitted by network entity 404 with the measurement configuration message 440. For example, the measurement purpose message 448 may be transmitted as a flag within the measurement configuration message 440 and/or within the measurement configuration identifier 442.

Moreover, for example, the communications system 400 may be an LTE network. The communications system 400 may include a number of evolved NodeBs (eNodeBs) (e.g., network entity 404) and UEs 402 and other network entities. An eNodeB may be a station that communicates with the UEs 402 and may also be referred to as a base station, an access point, etc. A NodeB is another example of a station that communicates with the UEs 402. Each eNodeB (e.g., network entity 404) may provide communication coverage for a particular geographic area. In 3GPP, the term “cell” can refer to a coverage area of an eNodeB and/or an eNodeB subsystem serving the coverage area, depending on the context in which the term is used.

An eNodeB (e.g., network entity 404) may provide communication coverage for a small cell and/or other types of cell. The term “small cell” (or “small coverage cell”), as used herein, may refer to an access point or to a corresponding coverage area of the access point, where the access point in this case has a relatively low transmit power or relatively small coverage as compared to, for example, the transmit power or coverage area of a macro network access point or macro cell. For instance, a macro cell may cover a relatively large geographic area, such as, but not limited to, several kilometers in radius. In contrast, a small cell may cover a relatively small geographic area, such as, but not limited to, a home, a building, or a floor of a building. As such, a small cell may include, but is not limited to, an apparatus such as a base station (BS), an access point, a femto node, a femtocell, a pico node, a micro node, a Node B, evolved Node B (eNB), home Node B (HNB) or home evolved Node B (HeNB). Therefore, the term “small cell,” as used herein, refers to a relatively low transmit power and/or a relatively small coverage area cell as compared to a macro cell. An eNodeB for a macro cell may be referred to as a macro eNodeB. An eNodeB for a pico cell may be referred to as a pico eNodeB. An eNodeB for a femto cell may be referred to as a femto eNodeB or a home eNodeB.

The UEs 402 may be dispersed throughout the telecommunications network system 400, and each UE 402 may be stationary or mobile. For example, the UE 402 may be referred to as a terminal, a mobile station, a subscriber unit, a station, etc. In another example, the UE 402 may be a cellular phone, a personal digital assistant (PDA), a wireless modem, a wireless communication device, a handheld device, a laptop computer, a cordless phone, a wireless local loop (WLL) station, a tablet, a netbook, a smart book, etc. The UE 402 may be able to communicate with macro eNodeBs, pico eNodeBs, femto eNodeBs, relays, etc. For example, in FIGS. 4A and 4B, transmissions may occur between a UE 402 and a serving eNodeB (e.g., network entity 404), which is an eNodeB designated to serve the UE 402 on the downlink and/or uplink.

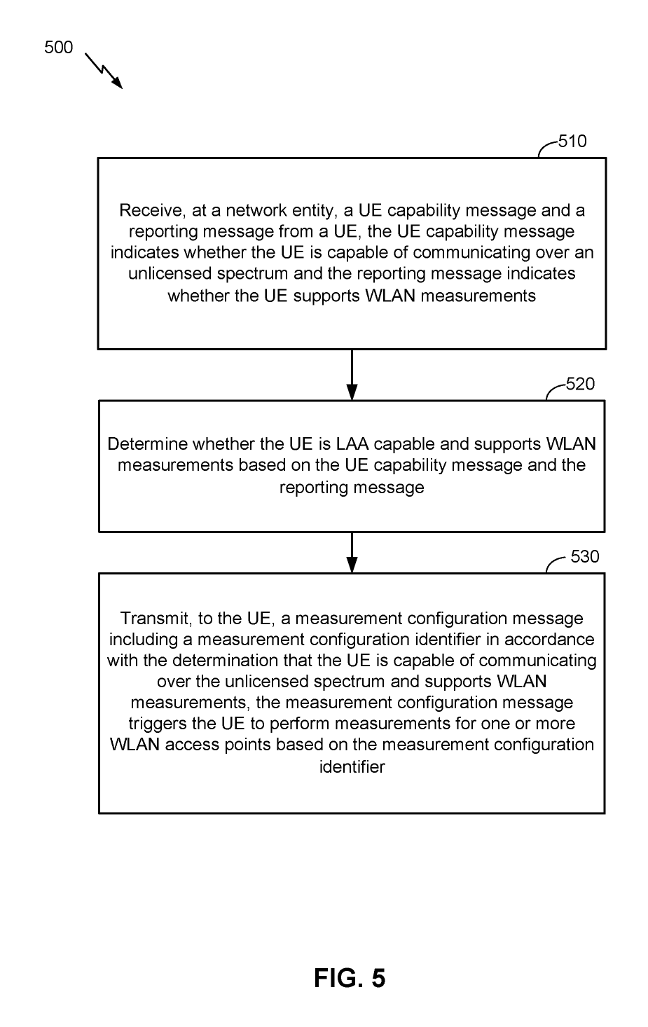

Referring to FIG. 5, in operation, a network entity such as network entity 404 (FIG. 4B) may perform an aspect of method 500 for communication in a wireless communications network. While, for purposes of simplicity of explanation, the methods herein are shown and described as a series of acts, it is to be understood and appreciated that the methods are not limited by the order of acts, as some acts may, in accordance with one or more aspects, occur in different orders and/or concurrently with other acts from that shown and described herein. For example, it is to be appreciated that the methods could alternatively be represented as a series of interrelated states or events, such as in a state diagram. Moreover, not all illustrated acts may be required to implement a method in accordance with one or more features described herein.

In an aspect, at block 510, the method 500 includes receiving, at a network entity, a UE capability message and a reporting message from a UE, the UE capability message indicates whether the UE is capable of communicating over an unlicensed spectrum and the reporting message indicates whether the UE supports WLAN measurements. In an aspect, for example, the network entity 404 (e.g., eNB), processor(s) 425, and/or memory 423 may execute transceiver 427 to receive the UE 402 capability message and a reporting message 490 from a UE, the UE capability message 480 indicates whether the UE 402 is capable of communicating over an unlicensed spectrum and the reporting message 490 indicates whether the UE 402 supports WLAN measurements.

In an aspect, at block 520, the method 500 includes determining whether the UE is capable of communicating over the unlicensed spectrum and supports WLAN measurements based on the UE capability message and the reporting message. In an aspect, for example, the network entity 404 (e.g., eNB), processor(s) 425, and/or memory 423 may execute the determining component 472 to determine whether the UE 402 is capable of communicating over the unlicensed spectrum and supports WLAN measurements based on the UE capability message 480 and the reporting message 490.

In an aspect, at block 530, the method 500 includes transmitting, to the UE, a measurement configuration message including a measurement configuration identifier in accordance with the determination that the UE is capable of communicating over the unlicensed spectrum and supports WLAN measurements, the measurement configuration message triggers the UE to perform measurements for one or more WLAN access points based on the measurement configuration identifier. In an aspect, for example, the network entity 404 (e.g., eNB), processor(s) 425, and/or memory 423 may execute the transceiver 427 to transmit, to the UE 402, a measurement configuration message 440 including a measurement configuration identifier 442 in accordance with the determination that the UE 402 is capable of communicating over the unlicensed spectrum and supports WLAN measurements, the measurement configuration message 440 triggers the UE 402 to perform measurements for one or more WLAN access points based on the measurement configuration identifier 442.

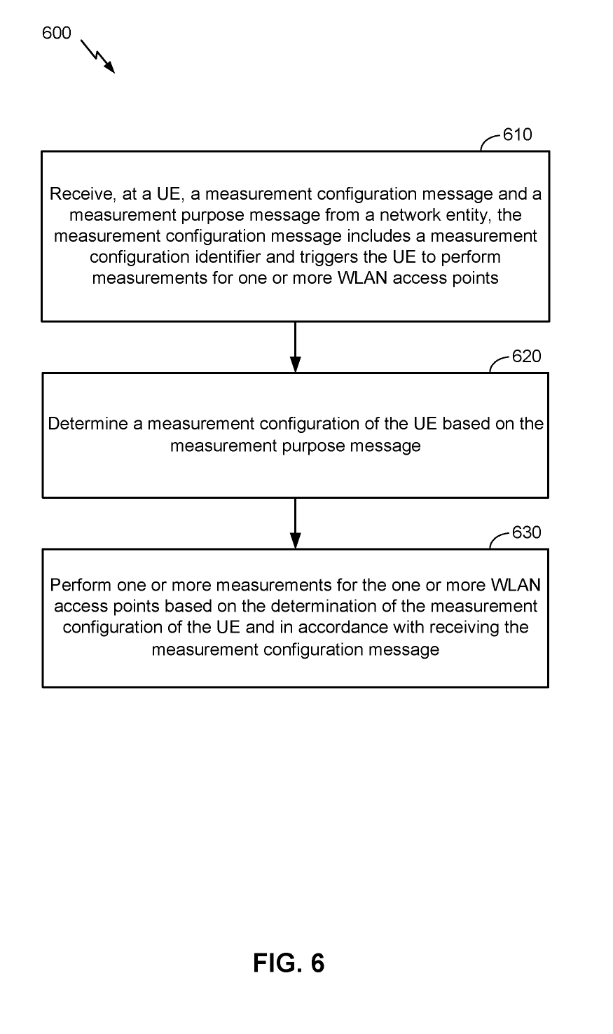

Referring to FIG. 6, in operation, a UE such as UE 402 (FIG. 4A) may perform an aspect of method 600 for communication in a wireless communications network. While, for purposes of simplicity of explanation, the methods herein are shown and described as a series of acts, it is to be understood and appreciated that the methods are not limited by the order of acts, as some acts may, in accordance with one or more aspects, occur in different orders and/or concurrently with other acts from that shown and described herein. For example, it is to be appreciated that the methods could alternatively be represented as a series of interrelated states or events, such as in a state diagram. Moreover, not all illustrated acts may be required to implement a method in accordance with one or more features described herein.

In an aspect, at block 610, the method 600 includes receiving, at a UE, a measurement configuration message and a measurement purpose message from a network entity, wherein the measurement configuration message includes a measurement configuration identifier and triggers the UE to perform measurements for one or more WLAN access points. In an aspect, for example, the UE 402, processor(s) 424, and/or memory 422 may execute the transceiver 426 to receive a measurement configuration message 440 and a measurement purpose message 448 from a network entity 404, the measurement configuration message includes a measurement configuration identifier 442 and triggers the UE 402 to perform measurements for one or more WLAN access points.

In an aspect, at block 620, the method 600 includes determining a measurement configuration of the UE based on the measurement purpose message. In an aspect, for example, the UE 402, processor(s) 424, and/or memory 422 may execute the determining component 444 to determine a measurement configuration of the UE 402 based on the measurement purpose message 448.

In an aspect, at block 630, the method 600 includes performing one or more measurements for the one or more WLAN access points based on the determination of the measurement configuration of the UE and in accordance with receiving the measurement configuration message. In an aspect, for example, the UE 402, processor(s) 424, and/or memory 422 may execute the performing component 446 to perform one or more measurements for the one or more WLAN access points based on the determination of the measurement configuration of the UE 402 and in accordance with receiving the measurement configuration message 440.

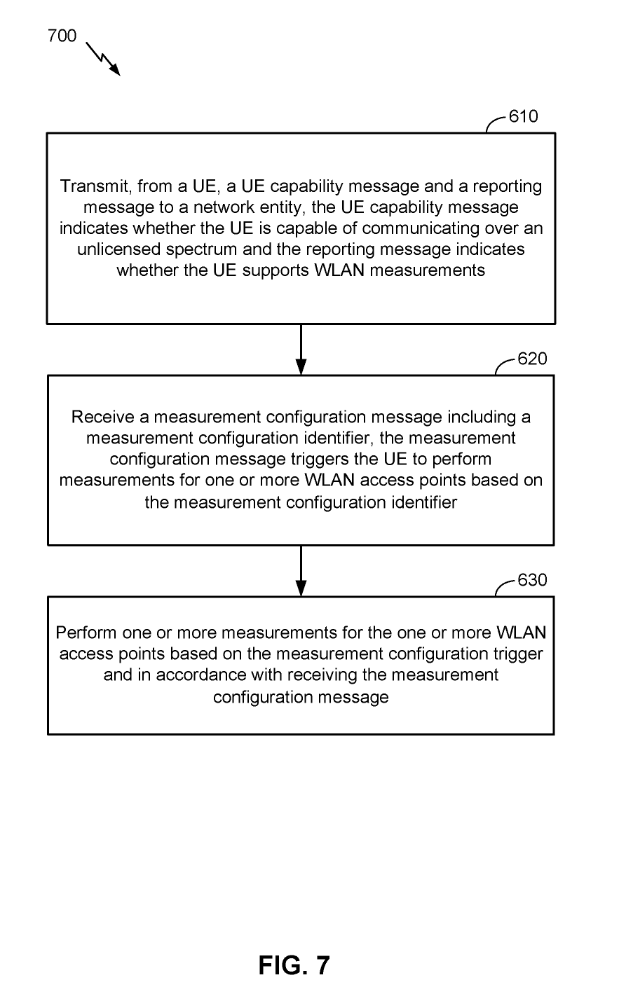

Referring to FIG. 7, in operation, a UE such as UE 402 (FIG. 4A) may perform an aspect of method 700 for communication in a wireless communications network. While, for purposes of simplicity of explanation, the methods herein are shown and described as a series of acts, it is to be understood and appreciated that the methods are not limited by the order of acts, as some acts may, in accordance with one or more aspects, occur in different orders and/or concurrently with other acts from that shown and described herein. For example, it is to be appreciated that the methods could alternatively be represented as a series of interrelated states or events, such as in a state diagram. Moreover, not all illustrated acts may be required to implement a method in accordance with one or more features described herein.

In an aspect, at block 710, the method 700 includes transmitting, from a UE, a UE capability message and a reporting message to a network entity, the UE capability message indicates whether the UE is capable of communicating over an unlicensed spectrum and the reporting message indicates whether the UE supports WLAN measurements. In an aspect, for example, the UE 402, processor(s) 424, and/or memory 422 may execute the transceiver 426 to transmit a UE capability message 480 and a reporting message 490 to a network entity 404, the UE capability message 480 indicates whether the UE 402 is capable of communicating over an unlicensed spectrum and the reporting message 490 indicates whether the UE 402 supports WLAN measurements.

In an aspect, at block 720, the method 700 includes receiving a measurement configuration message including a measurement configuration identifier, the measurement configuration message triggers the UE to perform measurements for one or more WLAN access points based on the measurement configuration identifier. In an aspect, for example, the UE 402, processor(s) 424, and/or memory 422 may execute the transceiver 426 to receive a measurement configuration message 440 including a measurement configuration identifier 442, the measurement configuration message 440 triggers the UE 402 to perform measurements for one or more WLAN access points based on the measurement configuration identifier 442.

In an aspect, at block 730, the method 700 includes performing one or more measurements for the one or more WLAN access points based on the measurement configuration trigger and in accordance with receiving the measurement configuration message. In an aspect, for example, the UE 402, processor(s) 424, and/or memory 422 may execute the performing component 446 to perform one or more measurements for the one or more WLAN access points based on the measurement configuration identifier 442 and in accordance with receiving the measurement configuration message 440.

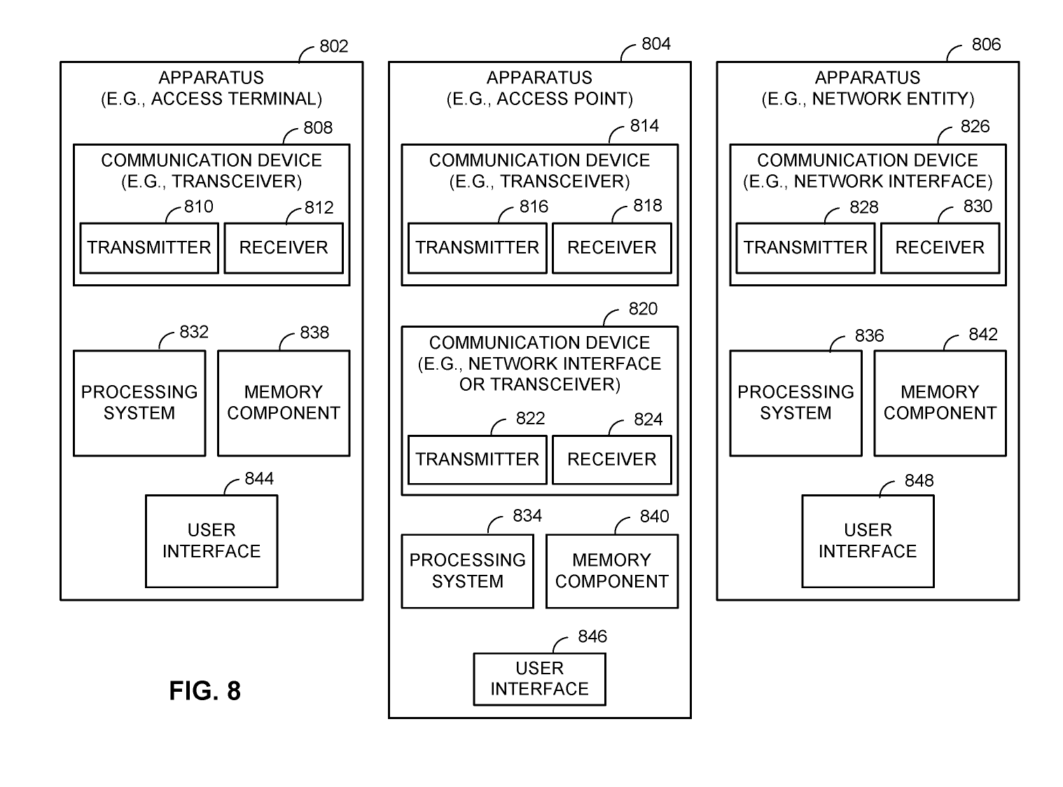

FIG. 8 illustrates several sample components (represented by corresponding blocks) that may be incorporated into an apparatus 802 (e.g., an access terminal), which may correspond to access terminal 102 (FIG. 1) or UE 402 (FIG. 4A) including measurement component 420 (FIG. 4A), and an apparatus 804 and an apparatus 806 (e.g., an access point 106 (FIG. 1) and a network entity 110 (FIG. 1), respectively), where one or both of which may correspond to network entity 404 including measurement configuration component 470 (FIG. 4B), to support operations as taught herein. As described herein, these components may be implemented in different types of apparatuses in different implementations (e.g., in an ASIC, in an SoC, etc.). The described components also may be incorporated into other apparatuses in a communication system. For example, other apparatuses in a system may include components similar to those described to provide similar functionality. Also, a given apparatus may contain one or more of the described components. For example, an apparatus may include multiple transceiver components that enable the apparatus to operate on multiple carriers and/or communicate via different technologies.

The apparatus 802 and the apparatus 804 each include at least one wireless communication device (represented by the communication devices 808 and 814 (and the communication device 820 if the apparatus 804 is a relay)) for communicating with other nodes via at least one designated radio access technology. Each communication device 808 includes at least one transmitter (represented by the transmitter 810) for transmitting and encoding signals (e.g., messages, indications, information, and so on) and at least one receiver (represented by the receiver 812) for receiving and decoding signals (e.g., messages, indications, information, pilots, and so on). Similarly, each communication device 814 includes at least one transmitter (represented by the transmitter 816) for transmitting signals (e.g., messages, indications, information, pilots, and so on) and at least one receiver (represented by the receiver 818) for receiving signals (e.g., messages, indications, information, and so on). If the apparatus 804 is a relay access point, each communication device 820 may include at least one transmitter (represented by the transmitter 822) for transmitting signals (e.g., messages, indications, information, pilots, and so on) and at least one receiver (represented by the receiver 824) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In some aspects, a wireless communication device (e.g., one of multiple wireless communication devices) of the apparatus 804 comprises a network listen module.

The apparatus 806 (and the apparatus 804 if it is not a relay access point) includes at least one communication device (represented by the communication device 826 and, optionally, 820) for communicating with other nodes. For example, the communication device 826 may comprise a network interface that is configured to communicate with one or more network entities via a wire-based or wireless backhaul. In some aspects, the communication device 826 may be implemented as a transceiver configured to support wire-based or wireless signal communication. This communication may involve, for example, sending and receiving: messages, parameters, or other types of information. Accordingly, in the example of FIG. 8, the communication device 826 is shown as comprising a transmitter 828 and a receiver 830. Similarly, if the apparatus 804 is not a relay access point, the communication device 820 may comprise a network interface that is configured to communicate with one or more network entities via a wire-based or wireless backhaul. As with the communication device 826, the communication device 820 is shown as comprising a transmitter 822 and a receiver 824.

The apparatuses 802, 804, and 806 also include other components that may be used in conjunction with dynamic bandwidth adaptation operations as taught herein. The apparatus 802 includes a processing system 832 for providing functionality relating to, for example, communicating with an access point to support dynamic bandwidth management as taught herein and for providing other processing functionality. The apparatus 804 includes a processing system 834 for providing functionality relating to, for example, dynamic bandwidth management as taught herein and for providing other processing functionality. The apparatus 806 includes a processing system 836 for providing functionality relating to, for example, dynamic bandwidth management as taught herein and for providing other processing functionality. The apparatuses 802, 804, and 806 include memory devices 838, 840, and 842 (e.g., each including a memory device), respectively, for maintaining information (e.g., information indicative of reserved resources, thresholds, parameters, and so on). In addition, the apparatuses 802, 804, and 806 include user interfaces 844, 846, and 848, respectively, for providing indications (e.g., audible and/or visual indications) to a user and/or for receiving user input (e.g., upon user actuation of a sensing device such a keypad, a touch screen, a microphone, and so on).

For convenience, the apparatus 802 is shown in FIG. 8 as including components that may be used in the various examples described herein. In practice, the illustrated blocks may have different functionality in different aspects.

The components of FIG. 8 may be implemented in various ways. In some implementations, the components of FIG. 8 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 808, 832, 838, and 844 may be implemented by processor and memory component(s) of the apparatus 802 (e.g., by execution of appropriate code and/or by appropriate configuration of processor components). Similarly, some or all of the functionality represented by blocks 814, 820, 834, 840, and 846 may be implemented by processor and memory component(s) of the apparatus 804 (e.g., by execution of appropriate code and/or by appropriate configuration of processor components). Also, some or all of the functionality represented by blocks 826, 836, 842, and 848 may be implemented by processor and memory component(s) of the apparatus 806 (e.g., by execution of appropriate code and/or by appropriate configuration of processor components).

Some of the access points referred to herein may comprise low-power access points. In a typical network, low-power access points (e.g., femto cells) are deployed to supplement conventional network access points (e.g., macro access points). For example, a low-power access point installed in a user home or in an enterprise environment (e.g., commercial buildings) may provide voice and high speed data service for access terminals supporting cellular radio communication (e.g., CDMA, WCDMA, UMTS, LTE, etc.). In general, these low-power access points provide more robust coverage and higher throughput for access terminals in the vicinity of the low-power access points.

As used herein, the term low-power access point refers to an access point having a transmit power (e.g., one or more of: maximum transmit power, instantaneous transmit power, nominal transmit power, average transmit power, or some other form of transmit power) that is less than a transmit power (e.g., as defined above) of any macro access point in the coverage area. In some implementations, each low-power access point has a transmit power (e.g., as defined above) that is less than a transmit power (e.g., as defined above) of the macro access point by a relative margin (e.g., 10 dBm or more). In some implementations, low-power access points such as femto cells may have a maximum transmit power of 20 dBm or less. In some implementations, low-power access points such as pico cells may have a maximum transmit power of 24 dBm or less. As described herein, however, these or other types of low-power access points may have a higher or lower maximum transmit power in other implementations (e.g., up to 1 Watt in some cases, up to 10 Watts in some cases, and so on).

Typically, low-power access points connect to the Internet via a broadband connection (e.g., a digital subscriber line (DSL) router, a cable modem, or some other type of modem) that provides a backhaul link to a mobile operator's network. Thus, a low-power access point deployed in a user home or business provides mobile network access to one or more devices via the broadband connection.

Various types of low-power access points may be employed in a given system. For example, low-power access points may be implemented as or referred to as femto cells, femto access points, small cells, femto nodes, home NodeBs (HNBs), home eNodeBs (HeNBs), access point base stations, pico cells, pico nodes, or micro cells.

For convenience, low-power access points may be referred to simply as small cells in the discussion that follows. Thus, as described herein, any discussion related to small cells herein may be equally applicable to low-power access points in general (e.g., to femto cells, to micro cells, to pico cells, etc.).

Small cells may be configured to support different types of access modes. For example, in an open access mode, a small cell may allow any access terminal to obtain any type of service via the small cell. In a restricted (or closed) access mode, a small cell may only allow authorized access terminals to obtain service via the small cell. For example, a small cell may only allow access terminals (e.g., so called home access terminals) belonging to a certain subscriber group (e.g., a closed subscriber group (CSG)) to obtain service via the small cell. In a hybrid access mode, alien access terminals (e.g., non-home access terminals, non-CSG access terminals) may be given limited access to the small cell. For example, a macro access terminal that does not belong to a small cell CSG may be allowed to access the small cell only if sufficient resources are available for all home access terminals currently being served by the small cell.

Thus, small cells operating in one or more of these access modes may be used to provide indoor coverage and/or extended outdoor coverage. By allowing access to users through adoption of a desired access mode of operation, small cells may provide improved service within the coverage area and potentially extend the service coverage area for users of a macro network.

Thus, in some aspects the teachings herein may be employed in a network that includes macro scale coverage (e.g., a large area cellular network such as a third generation (3G) network, typically referred to as a macro cell network or a WAN) and smaller scale coverage (e.g., a residence-based or building-based network environment, typically referred to as a LAN). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a small cell. As described herein, the teachings herein may be applicable to nodes associated with other types of coverage areas. For example, a pico access point may provide coverage (e.g., coverage within a commercial building) over an area that is smaller than a macro area and larger than a femto cell area. In various applications, other terminology may be used to reference a macro access point, a small cell, or other access point-type nodes. For example, a macro access point may be configured or referred to as an access node, base station, access point, eNodeB, macro cell, and so on. In some implementations, a node may be associated with (e.g., referred to as or divided into) one or more cells or sectors. A cell or sector associated with a macro access point, a femto access point, or a pico access point may be referred to as a macro cell, a femto cell, or a pico cell, respectively.

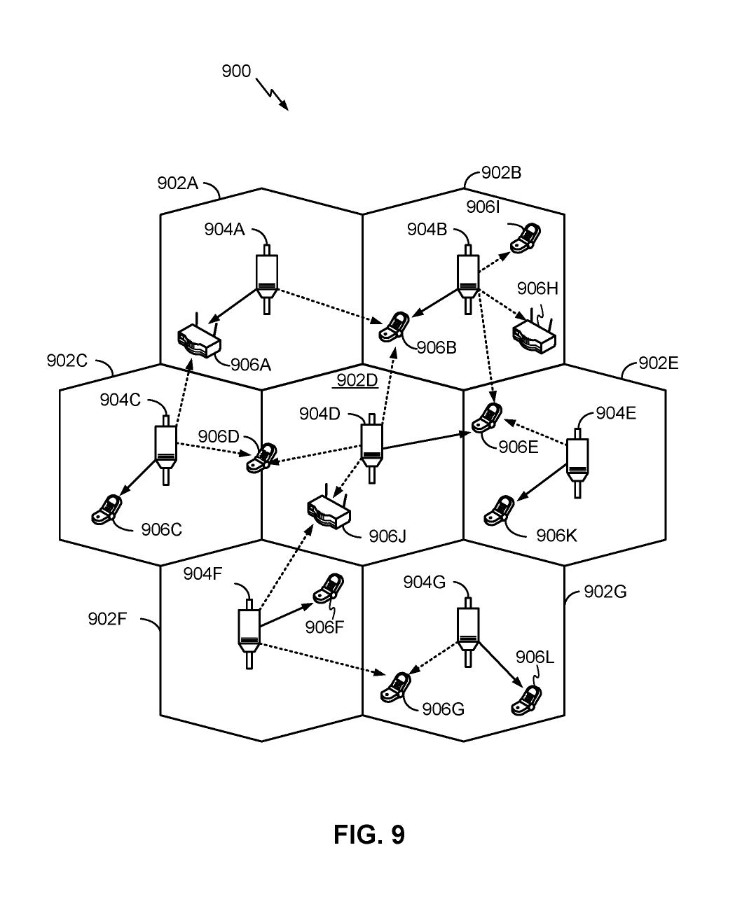

FIG. 9 illustrates a wireless communication system 900, configured to support a number of users, including one or more access terminals each including a measurement component 420 and one or more network entities each having measurement configuration components 470 that operate to configure WLAN measurements for unlicensed spectrum communications.

The system 900 provides communication for multiple cells 902, such as, for example, macro cells 902A-902G, with each cell being serviced by a corresponding access point 904 (e.g., access points 904A-904G), which may correspond to the access point 106 (FIG. 1) or network entity 404 (FIG. 4B) including measurement configuration component 470 (FIG. 4). As shown in FIG. 9, access terminals 906 (e.g., access terminals 906A-906L), which may correspond to access terminal 102 (FIG. 1) or UE 402 (FIG. 4A) including measurement configuration component 420 (FIG. 4A), may be dispersed at various locations throughout the system over time. Each access terminal 906 may communicate with one or more access points 904 on a forward link (FL) and/or a reverse link (RL) at a given moment, depending upon whether the access terminal 906 is active and whether it is in soft handoff, for example. Wireless communication system 900 may provide service over a large geographic region. For example, macro cells 902A-902G may cover a few blocks in a neighborhood or several miles in a rural environment.

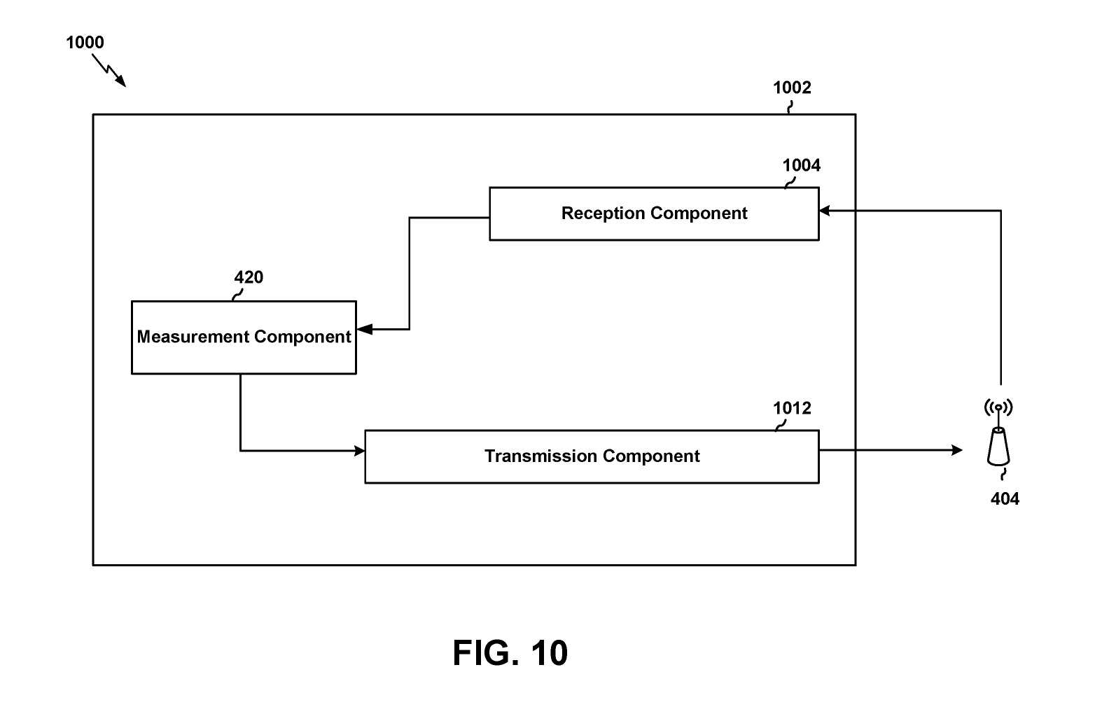

FIG. 10 is a conceptual data flow diagram 1000 illustrating the data flow between different means/components in an exemplary apparatus 1002 that includes measurement component 420. The apparatus 1002 may be a UE, for example, UE 402 of FIG. 4A. The apparatus 1002 includes reception component 1004 that, in an aspect, receives a measurement configuration message including a measurement configuration identifier. Further, in some aspects, reception component 1004 may receive a measurement purpose message. The apparatus 1002 includes a measurement component 420 that determines a relative position of the received subframe with respect to a discovery window, and selects a scrambling sequence from a plurality of scrambling sequences based on the relative position of the received subframe with respect to the discovery window. Further, the measurement configuration component 420 may perform one or more measurements for the one or more access points based on the measurement configuration trigger and in accordance with receiving the measurement configuration message. In an aspect, the apparatus 1002 further includes a transmission component 1012 that transmits a UE capability message 480 and a reporting message 490 to a network entity. Further, in some aspects, the transmission component 1012 may transmit a report of a highest ranked access point in accordance with performing the one or more measurements for the one or more access points.

The apparatus may include additional components that perform each of the blocks of the algorithm in the aforementioned flowcharts of FIGS. 6 and 7. As such, each block in the aforementioned flowcharts of FIGS. 6 and 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof

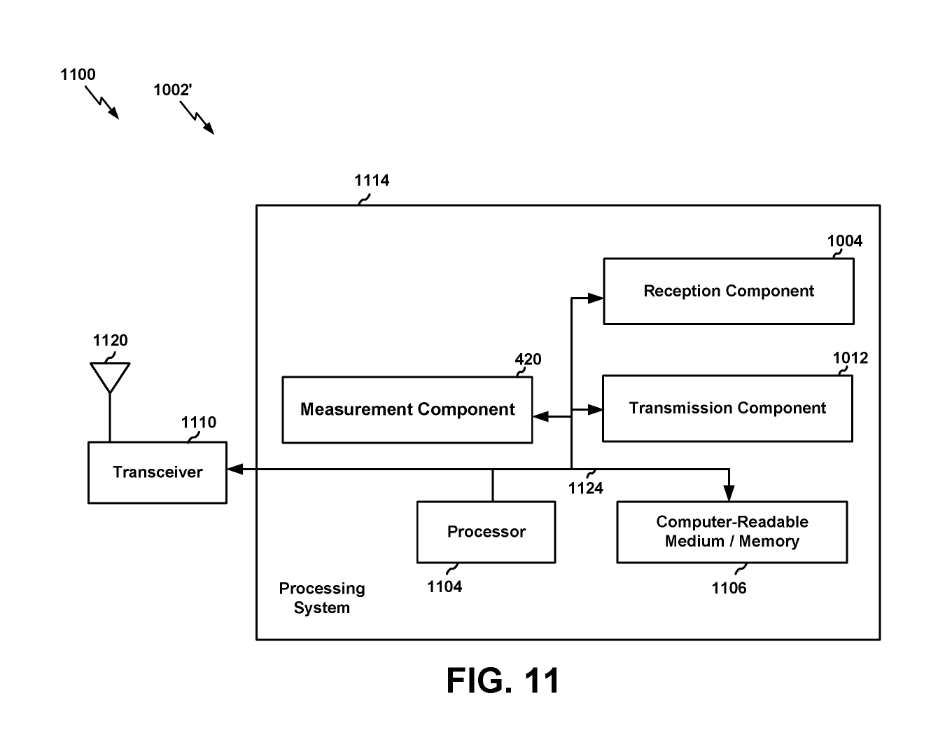

FIG. 11 is a diagram 1100 illustrating an example of a hardware implementation for an apparatus 1002′ employing a processing system 1114 that includes the measurement component 420. The processing system 1114 may be implemented with a bus architecture, represented generally by a bus 1124. The bus 1124 may include any number of interconnecting buses and bridges depending on the specific application of the processing system 1114 and the overall design constraints. The bus 1124 links together various circuits including one or more processors and/or hardware components, represented by the processor 1104, which may be the same as or similar to processor(s) 424 (FIG. 4A), the components 1004, 1012, and the computer-readable medium / memory 1106, which may be the same as or similar to memory 422 (FIG. 4A). The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114, specifically the reception component 1004. In addition, the transceiver 1110 receives information from the processing system 1114, specifically the transmission component 1112, and based on the received information, generates a signal to be applied to the one or more antennas 1120. The processing system 1114 includes a processor 1104 coupled to a computer-readable medium / memory 1106. The processor 1104 is responsible for general processing, including the execution of software stored on the computer-readable medium / memory 1106. The software, when executed by the processor 1104, causes the processing system 1114 to perform the various functions described supra for any particular apparatus. The computer-readable medium / memory 1106 may also be used for storing data that is manipulated by the processor 1104 when executing software. The processing system 1114 further includes at least one of the components 1004, 1010, and 1012. The components may be software components running in the processor 1104, resident/stored in the computer readable medium / memory 1106, one or more hardware components coupled to the processor 1104, or some combination thereof

In one configuration, the apparatus 1102/1002′ for wireless communication includes means for receiving a measurement configuration message and a measurement purpose message from a network entity, wherein the measurement configuration message includes a measurement configuration identifier and triggers the UE to perform measurements for one or more access points. The apparatus further includes means for determining a measurement configuration of the UE based on the measurement purpose message. Additionally, the apparatus includes means for performing one or more measurements for the one or more access points based on the determination of the measurement configuration of the UE and in accordance with receiving the measurement configuration message.

In another configuration, the apparatus 1102/1002′ for wireless communication includes means for transmitting a UE capability message and a reporting message to a network entity, wherein the UE capability message indicates whether the UE is capable of communicating over an unlicensed spectrum and the reporting message indicates whether the UE supports WLAN measurements. The apparatus further includes means for receiving a measurement configuration message including a measurement configuration identifier, wherein the measurement configuration message triggers the UE to perform measurements for one or more access points based on the measurement configuration identifier. Additionally, the apparatus includes means for performing one or more measurements for the one or more access points based on the measurement configuration trigger and in accordance with receiving the measurement configuration message.

The aforementioned means may be one or more of the aforementioned components of the apparatus 1102 and/or the processing system 1114 of the apparatus 1002′ configured to perform the functions recited by the aforementioned means. In some aspects, the processing system 1114 may include the TX Processor 268 (FIG. 2), the RX Processor 256 (FIG. 2), and the controller/processor 259 (FIG. 2). As such, in one configuration, the aforementioned means may be the TX Processor 268 (FIG. 2), the RX Processor 256 (FIG. 2), and the controller/processor 259 (FIG. 2) configured to perform the functions recited by the aforementioned means.

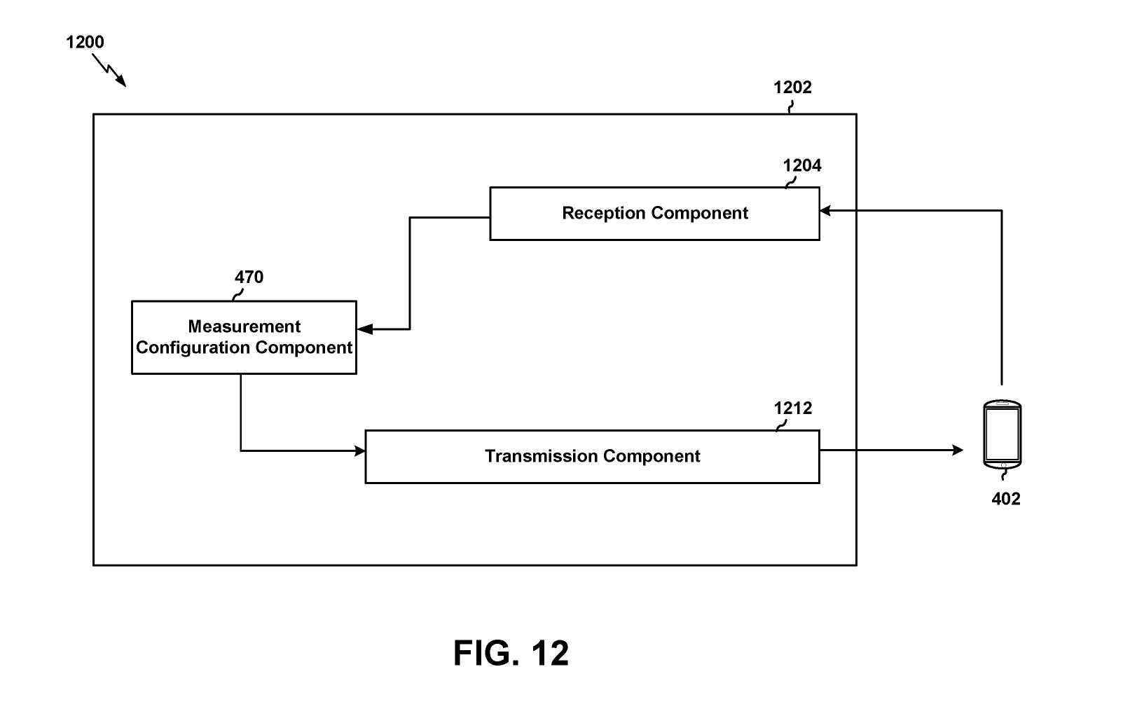

FIG. 12 is a conceptual data flow diagram 1200 illustrating the data flow between different means/components in an exemplary apparatus 1202 that includes the measurement configuration component 470. The apparatus 1202 may be a network entity, for example, network entity 404 of FIG. 4B. The apparatus 1202 includes a reception component 1204 that, in an aspect, receiving, at a network entity, a UE capability message and a reporting message from a UE. The apparatus 1202 includes the measurement configuration component 470 that determines whether the UE is capable of communicating over the unlicensed spectrum and supports WLAN measurements based on the UE capability message and the reporting message. In an aspect, the apparatus 1202 further includes a transmission component 1212 that transmits a measurement configuration message including a measurement configuration identifier.

The apparatus may include additional components that perform each of the blocks of the algorithm in the aforementioned flowcharts of FIG. 5. As such, each block in the aforementioned flowcharts of FIG. 5 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof

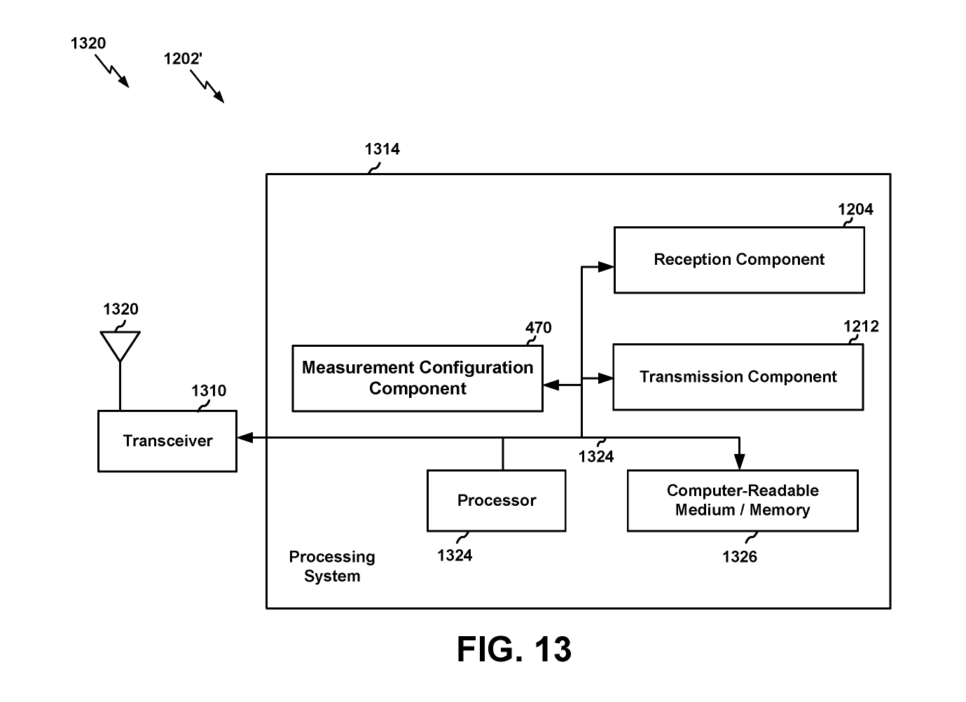

FIG. 13 is a diagram 1300 illustrating an example of a hardware implementation for an apparatus 1202′ employing a processing system 1314 that includes measurement configuration component 470. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware components, represented by the processor 1304, which may be the same as or similar to processor(s) 425 (FIG. 4B), the components 1204, 1212, and the computer-readable medium / memory 1306, which may be the same as or similar to memory 423 (FIG. 4B). The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The transceiver 1310 receives a signal from the one or more antennas 1320, extracts information from the received signal, and provides the extracted information to the processing system 1314, specifically the reception component 1204. In addition, the transceiver 1310 receives information from the processing system 1314, specifically the transmission component 1312, and based on the received information, generates a signal to be applied to the one or more antennas 1320. The processing system 1314 includes a processor 1304 coupled to a computer-readable medium / memory 1306. The processor 1304 is responsible for general processing, including the execution of software stored on the computer-readable medium / memory 1306. The software, when executed by the processor 1304, causes the processing system 1314 to perform the various functions described supra for any particular apparatus. The computer-readable medium / memory 1306 may also be used for storing data that is manipulated by the processor 1304 when executing software. The processing system 1314 further includes at least one of the components 1204, 1210, and 1212. The components may be software components running in the processor 1304, resident/stored in the computer readable medium / memory 1306, one or more hardware components coupled to the processor 1304, or some combination thereof

In one configuration, the apparatus 1302/1202′ for wireless communication includes means for receiving, at a network entity, a UE capability message and a reporting message from a UE, wherein the UE capability message indicates whether the UE is capable of communicating over an unlicensed spectrum and the reporting message indicates whether the UE supports WLAN measurements. The apparatus further includes means for determining whether the UE is capable of communicating over the unlicensed spectrum and supports WLAN measurements based on the UE capability message and the reporting message. Additionally, the apparatus includes means for transmitting, to the UE, a measurement configuration message including a measurement configuration identifier in accordance with the determination that the UE is capable of communicating over the unlicensed spectrum and supports WLAN measurements, wherein the measurement configuration message triggers the UE to perform measurements for one or more access points based on the measurement configuration identifier.

The aforementioned means may be one or more of the aforementioned components of the apparatus 1302 and/or the processing system 1314 of the apparatus 1202′ configured to perform the functions recited by the aforementioned means. In some aspects, the processing system 1314 may include the TX Processor 216 (FIG. 2), the RX Processor 270 (FIG. 2), and the controller/processor 275 (FIG. 2). As such, in one configuration, the aforementioned means may be the TX Processor 216 (FIG. 2), the RX Processor 270 (FIG. 2), and the controller/processor 275 (FIG. 2) configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the disclosure can include a computer readable medium embodying a method for scheduling a first set of subframes in a frame duration for traffic based at least in part on a first configuration for communications in an unlicensed frequency band; scheduling, based at least in part on the first configuration, a second set of subframes in the frame duration for detection of a primary user of the unlicensed frequency band (e.g., radar detection); and adjusting a number of subframes in the first and second set of subframes based on a second configuration for communications, wherein the second configuration for communications is identified based on a type of primary user being detected (e.g., radar type). Accordingly, the disclosure is not limited to the illustrated examples.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of wireless communication, comprising:
receiving, at a network entity, a user equipment (UE) capability message and a reporting message from a UE, wherein the UE capability message indicates whether the UE is capable of communicating over an unlicensed spectrum and the reporting message indicates whether the UE supports Wide Local Area Network (WLAN) measurements;
determining whether the UE is capable of communicating over the unlicensed spectrum and supports WLAN measurements based on the UE capability message and the reporting message; and
transmitting, to the UE, a measurement configuration message including a measurement configuration identifier in accordance with the determination that the UE is capable of communicating over the unlicensed spectrum and supports WLAN measurements, wherein the measurement configuration message triggers the UE to perform measurements for one or more WLAN access points based on the measurement configuration identifier.

2. The method of claim 1, wherein the measurement configuration message triggers the UE to perform measurements for each WLAN access point within a geographic area of the UE corresponding to the measurement configuration identifier.

3. The method of claim 1, wherein the measurement configuration message triggers the UE to perform measurements for each WLAN access point over the unlicensed spectrum corresponding to the measurement configuration identifier.

4. The method of claim 1, wherein the measurement configuration message triggers the UE to perform measurements for a subset of WLAN access points of the one or more WLAN access points within a geographic area of the UE corresponding to the measurement configuration identifier.

5. The method of claim 1, wherein the measurement configuration message triggers the UE to perform WLAN measurements for each WLAN access point corresponding to the measurement configuration identifier.

6. The method of claim 1, further comprising transmitting, to the UE, a measurement purpose message either separately or with the measurement configuration message, wherein the measurement purpose message indicates at least one of the measurements are not to be used for Long Term Evolution (LTE) WLAN Aggregation or Interworking or that the measurements are used to assist the network entity with channel selection.

7. The method of claim 1, wherein the measurement configuration message triggers the UE to perform measurements for the one or more WLAN access points without including the measurement configuration identifier.

8. A method of wireless communication, comprising:
receiving, at a user equipment (UE), a measurement configuration message and a measurement purpose message from a network entity, wherein the measurement configuration message includes a measurement configuration identifier and triggers the UE to perform measurements for one or more WLAN access points;
determining a measurement configuration of the UE based on the measurement purpose message; and
performing one or more measurements for the one or more WLAN access points based on the determination of the measurement configuration of the UE and in accordance with receiving the measurement configuration message.

9. The method of claim 8, wherein determining the measurement configuration of the UE based on the measurement purpose message further comprises:
determining that the one or more measurements correspond to one or more Long Term Evolution (LTE) WLAN Aggregation or Interworking measurements;
determining that a Wi-Fi radio of the UE is engaged; and
wherein performing the one or more measurements for the one or more WLAN access points further comprises foregoing performance of WLAN measurements for the one or more WLAN access points based on the determination that the one or more measurements correspond to the one or more LTE WLAN Aggregation or Interworking measurements and that the Wi-Fi radio of the UE is engaged.

10. The method of claim 8, wherein determining the measurement configuration of the UE based on the measurement purpose message further comprises:
determining that the one or more measurements are not to be used for Long Term Evolution (LTE) WLAN Aggregation or Interworking or correspond to one or more unlicensed cellular operations;
determining that a Wi-Fi radio of the UE is engaged; and
wherein performing the one or more measurements for the one or more WLAN access points further comprises performing one or more WLAN measurements for the one or more WLAN access points based on the determination that the one or more measurements are not to be used for LTE WLAN Aggregation or Interworking or correspond to the one or more unlicensed cellular operations and that the Wi-Fi radio of the UE is engaged.

11. The method of claim 8, wherein determining the measurement configuration of the UE based on the measurement purpose message further comprises:
determining that the one or more measurements correspond to one or more Long Term Evolution (LTE) WLAN Aggregation or Interworking measurements;
determining that one or more resources required for performing the LWA measurements is engaged for unlicensed spectrum communications; and
wherein performing the one or more measurements for the one or more WLAN access points further comprises foregoing performance of LTE WLAN Aggregation or Interworking measurements for the one or more WLAN access points based on the determination that the one or more measurements correspond to the one or more LTE WLAN Aggregation measurements and that the one or more resources required for performing the LTE WLAN Aggregation or Interworking measurements is engaged for the unlicensed spectrum communications.

12. The method of claim 8, wherein the measurement configuration message triggers the UE to perform measurements for each WLAN access point within a geographic area of the UE corresponding to the measurement configuration identifier.

13. The method of claim 8, wherein the measurement configuration message triggers the UE to perform measurements for each WLAN access point over an unlicensed spectrum corresponding to the measurement configuration identifier.

14. The method of claim 8, wherein the measurement configuration message triggers the UE to perform measurements for a subset of WLAN access points of the one or more WLAN access points within a geographic area of the UE corresponding to the measurement configuration identifier.

15. A method of wireless communication, comprising:
transmitting, from a user equipment (UE), a UE capability message and a reporting message to a network entity, wherein the UE capability message indicates whether the UE is capable of communicating over an unlicensed spectrum and the reporting message indicates whether the UE supports Wide Local Area Network (WLAN) measurements;
receiving a measurement configuration message including a measurement configuration identifier, wherein the measurement configuration message triggers the UE to perform measurements for one or more WLAN access points based on the measurement configuration identifier; and
performing one or more measurements for the one or more WLAN access points based on the measurement configuration trigger and in accordance with receiving the measurement configuration message.

16. The method of claim 15, wherein the measurement configuration message triggers the UE to perform measurements for each WLAN access point within a geographic area of the UE corresponding to the measurement configuration identifier.

17. The method of claim 15, wherein the measurement configuration message triggers the UE to perform measurements for each WLAN access point over the unlicensed spectrum corresponding to the measurement configuration identifier.

18. The method of claim 15, wherein the measurement configuration message triggers the UE to perform measurements for a subset of WLAN access points of the one or more access points within a geographic area of the UE corresponding to the measurement configuration identifier.

19. The method of claim 15, wherein the measurement configuration message triggers the UE to perform WLAN measurements for each WLAN access point corresponding to the measurement configuration identifier.

20. The method of claim 15, further comprising receiving a measurement purpose message either separately or with the measurement configuration message, wherein the measurement purpose message indicates that the measurements are not to be used for Long Term Evolution (LTE) WLAN Aggregation or Interworking.

21. The method of claim 15, wherein the measurement configuration message triggers the UE to perform measurements for the one or more WLAN access points without including the measurement configuration identifier.

22. The method of claim 15, further comprising reporting, to the network entity, a highest ranked WLAN access point in accordance with performing the one or more measurements for the one or more WLAN access points.

23. A computer-readable medium storing computer executable code for wireless communications, comprising:
code for receiving, at a network entity, a user equipment (UE) capability message and a reporting message from a UE, wherein the UE capability message indicates whether the UE is capable of communicating over an unlicensed spectrum and the reporting message indicates whether the UE supports Wide Local Area Network (WLAN) measurements;
code for determining whether the UE is capable of communicating over the unlicensed spectrum and supports WLAN measurements based on the UE capability message and the reporting message; and
code for transmitting, to the UE, a measurement configuration message including a measurement configuration identifier in accordance with the determination that the UE is capable of communicating over the unlicensed spectrum and supports WLAN measurements, wherein the measurement configuration message triggers the UE to perform measurements for one or more WLAN access points based on the measurement configuration identifier.

24. The computer-readable medium of claim 23, wherein the measurement configuration message triggers the UE to perform measurements for each WLAN access point within a geographic area of the UE corresponding to the measurement configuration identifier.

25. The computer-readable medium of claim 23, wherein the measurement configuration message triggers the UE to perform measurements for each WLAN access point over the unlicensed spectrum corresponding to the measurement configuration identifier.

26. The computer-readable medium of claim 23, wherein the measurement configuration message triggers the UE to perform measurements for a subset of WLAN access points of the one or more WLAN access points within a geographic area of the UE corresponding to the measurement configuration identifier.

27. The computer-readable medium of claim 23, wherein the measurement configuration message triggers the UE to perform WLAN measurements for each WLAN access point corresponding to the measurement configuration identifier.

28. The computer-readable medium of claim 23, further comprising code for transmitting, to the UE, a measurement purpose message either separately or with the measurement configuration message, wherein the measurement purpose message indicates at least one of the measurements are not to be used for Long Term Evolution (LTE) WLAN Aggregation or Interworking or that the measurements are used to assist the network entity with channel selection.

29. The computer-readable medium of claim 23, wherein the measurement configuration message triggers the UE to perform measurements for the one or more WLAN access points without including the measurement configuration identifier.

30. An apparatus for wireless communications, comprising:
a memory; and
a processor coupled to the memory and configured to:
receive, at a network entity, a user equipment (UE) capability message and a reporting message from a UE, wherein the UE capability message indicates whether the UE is capable of communicating over an unlicensed spectrum and the reporting message indicates whether the UE supports Wide Local Area Network (WLAN) measurements;
determine whether the UE is capable of communicating over the unlicensed spectrum and supports WLAN measurements based on the UE capability message and the reporting message; and
transmit, to the UE, a measurement configuration message including a measurement configuration identifier in accordance with the determination that the UE is capable of communicating over the unlicensed spectrum and supports WLAN measurements, wherein the measurement configuration message triggers the UE to perform measurements for one or more WLAN access points based on the measurement configuration identifier.

31. The apparatus of claim 30, wherein the measurement configuration message triggers the UE to perform measurements for each WLAN access point within a geographic area of the UE corresponding to the measurement configuration identifier.

32. The apparatus of claim 30, wherein the measurement configuration message triggers the UE to perform measurements for each WLAN access point over the unlicensed spectrum corresponding to the measurement configuration identifier.

33. The apparatus of claim 30, wherein the measurement configuration message triggers the UE to perform measurements for a subset of WLAN access points of the one or more WLAN access points within a geographic area of the UE corresponding to the measurement configuration identifier.

34. The apparatus of claim 30, wherein the measurement configuration message triggers the UE to perform WLAN measurements for each WLAN access point corresponding to the measurement configuration identifier.

35. The apparatus of claim 30, wherein the processor is further configured to transmit, to the UE, a measurement purpose message either separately or with the measurement configuration message, wherein the measurement purpose message indicates at least one of the measurements are not to be used for Long Term Evolution (LTE) WLAN Aggregation or Interworking or that the measurements are used to assist the network entity with channel selection.

36. The apparatus of claim 30, wherein the measurement configuration message triggers the UE to perform measurements for the one or more WLAN access points without including the measurement configuration identifier.

37. A computer-readable medium storing computer executable code for wireless communications, comprising:
code for receiving, at a user equipment (UE), a measurement configuration message and a measurement purpose message from a network entity, wherein the measurement configuration message includes a measurement configuration identifier and triggers the UE to perform measurements for one or more WLAN access points;
code for determining a measurement configuration of the UE based on the measurement purpose message; and
code for performing one or more measurements for the one or more WLAN access points based on the determination of the measurement configuration of the UE and in accordance with receiving the measurement configuration message.

38. The computer-readable medium of claim 37, wherein code for determining the measurement configuration of the UE based on the measurement purpose message further comprises:
code for determining that the one or more measurements correspond to one or more Long Term Evolution (LTE) WLAN Aggregation or Interworking measurements;
code for determining that a Wi-Fi radio of the UE is engaged; and
wherein code for performing the one or more measurements for the one or more WLAN access points further comprises code for foregoing performance of WLAN measurements for the one or more WLAN access points based on the determination that the one or more measurements correspond to the one or more LTE WLAN Aggregation or Interworking measurements and that the Wi-Fi radio of the UE is engaged.

39. The computer-readable medium of claim 37, wherein code for determining the measurement configuration of the UE based on the measurement purpose message further comprises:
code for determining that the one or more measurements are not to be used for Long Term Evolution (LTE) WLAN Aggregation or Interworking or correspond to one or more unlicensed cellular operations;
code for determining that a Wi-Fi radio of the UE is engaged; and
wherein code for performing the one or more measurements for the one or more WLAN access points further comprises code for performing one or more WLAN measurements for the one or more WLAN access points based on the determination that the one or more measurements are not to be used for LTE WLAN Aggregation or Interworking or correspond to the one or more unlicensed cellular operations and that the Wi-Fi radio of the UE is engaged.

40. The computer-readable medium of claim 37, wherein code for determining the measurement configuration of the UE based on the measurement purpose message further comprises:
code for determining that the one or more measurements correspond to one or more Long Term Evolution (LTE) WLAN Aggregation or Interworking measurements;
code for determining that one or more resources required for performing the LWA measurements is engaged for unlicensed spectrum communications; and
wherein code for performing the one or more measurements for the one or more WLAN access points further comprises code for foregoing performance of LTE WLAN Aggregation or Interworking measurements for the one or more WLAN access points based on the determination that the one or more measurements correspond to the one or more LTE WLAN Aggregation measurements and that the one or more resources required for performing the LTE WLAN Aggregation or Interworking measurements is engaged for the unlicensed spectrum communications.

41. The computer-readable medium of claim 37, wherein the measurement configuration message triggers the UE to perform measurements for each WLAN access point within a geographic area of the UE corresponding to the measurement configuration identifier.

42. The computer-readable medium of claim 37, wherein the measurement configuration message triggers the UE to perform measurements for each WLAN access point over an unlicensed spectrum corresponding to the measurement configuration identifier.

43. The computer-readable medium of claim 37, wherein the measurement configuration message triggers the UE to perform measurements for a subset of WLAN access points of the one or more WLAN access points within a geographic area of the UE corresponding to the measurement configuration identifier.

44. An apparatus for wireless communications, comprising:
a memory; and
a processor coupled to the memory and configured to:
receive, at a user equipment (UE), a measurement configuration message and a measurement purpose message from a network entity, wherein the measurement configuration message includes a measurement configuration identifier and triggers the UE to perform measurements for one or more WLAN access points;
determine a measurement configuration of the UE based on the measurement purpose message; and
perform one or more measurements for the one or more WLAN access points based on the determination of the measurement configuration of the UE and in accordance with receiving the measurement configuration message.

45. The apparatus of claim 44, wherein the processor configured to determine the measurement configuration of the UE based on the measurement purpose message is further configured to:
determine that the one or more measurements correspond to one or more Long Term Evolution (LTE) WLAN Aggregation or Interworking measurements;
determine that a Wi-Fi radio of the UE is engaged; and
wherein the processor configured to perform the one or more measurements for the one or more WLAN access points is further configured to forgo performance of WLAN measurements for the one or more WLAN access points based on the determination that the one or more measurements correspond to the one or more LTE WLAN Aggregation or Interworking measurements and that the Wi-Fi radio of the UE is engaged.

46. The apparatus of claim 44, wherein the processor configured to determine the measurement configuration of the UE based on the measurement purpose message is further configured to:
determine that the one or more measurements are not to be used for Long Term Evolution (LTE) WLAN Aggregation or Interworking or correspond to one or more unlicensed cellular operations;
determine that a Wi-Fi radio of the UE is engaged; and
wherein the processor configured to perform the one or more measurements for the one or more WLAN access points is further configured to perform one or more WLAN measurements for the one or more WLAN access points based on the determination that the one or more measurements are not to be used for LTE WLAN Aggregation or Interworking or correspond to the one or more unlicensed cellular operations and that the Wi-Fi radio of the UE is engaged.

47. The apparatus of claim 44, wherein the processor configured to determine the measurement configuration of the UE based on the measurement purpose message is further configured to:
determine that the one or more measurements correspond to one or more Long Term Evolution (LTE) WLAN Aggregation or Interworking measurements;
determine that one or more resources required for performing the LWA measurements is engaged for unlicensed spectrum communications; and
wherein the processor configured to perform the one or more measurements for the one or more WLAN access points is further configured to forego performance of LTE WLAN Aggregation or Interworking measurements for the one or more WLAN access points based on the determination that the one or more measurements correspond to the one or more LTE WLAN Aggregation measurements and that the one or more resources required for performing the LTE WLAN Aggregation or Interworking measurements is engaged for the unlicensed spectrum communications.

48. The apparatus of claim 44, wherein the measurement configuration message triggers the UE to perform measurements for each WLAN access point within a geographic area of the UE corresponding to the measurement configuration identifier.

49. The apparatus of claim 44, wherein the measurement configuration message triggers the UE to perform measurements for each WLAN access point over an unlicensed spectrum corresponding to the measurement configuration identifier.

50. The apparatus of claim 44, wherein the measurement configuration message triggers the UE to perform measurements for a subset of WLAN access points of the one or more WLAN access points within a geographic area of the UE corresponding to the measurement configuration identifier.

51. A computer-readable medium storing computer executable code for wireless communications, comprising:
code for transmitting, from a user equipment (UE), a UE capability message and a reporting message to a network entity, wherein the UE capability message indicates whether the UE is capable of communicating over an unlicensed spectrum and the reporting message indicates whether the UE supports Wide Local Area Network (WLAN) measurements;
code for receiving a measurement configuration message including a measurement configuration identifier, wherein the measurement configuration message triggers the UE to perform measurements for one or more WLAN access points based on the measurement configuration identifier; and
code for performing one or more measurements for the one or more WLAN access points based on the measurement configuration trigger and in accordance with receiving the measurement configuration message.

52. The computer-readable medium of claim 51, wherein the measurement configuration message triggers the UE to perform measurements for each WLAN access point within a geographic area of the UE corresponding to the measurement configuration identifier.

53. The computer-readable medium of claim 51, wherein the measurement configuration message triggers the UE to perform measurements for each WLAN access point over the unlicensed spectrum corresponding to the measurement configuration identifier.

54. The computer-readable medium of claim 51, wherein the measurement configuration message triggers the UE to perform measurements for a subset of WLAN access points of the one or more access points within a geographic area of the UE corresponding to the measurement configuration identifier.

55. The computer-readable medium of claim 51, wherein the measurement configuration message triggers the UE to perform WLAN measurements for each WLAN access point corresponding to the measurement configuration identifier.

56. The computer-readable medium of claim 51, further comprising code for receiving a measurement purpose message either separately or with the measurement configuration message, wherein the measurement purpose message indicates that the measurements are not to be used for Long Term Evolution (LTE) WLAN Aggregation or Interworking.

57. The computer-readable medium of claim 51, wherein the measurement configuration message triggers the UE to perform measurements for the one or more WLAN access points without including the measurement configuration identifier.

58. The computer-readable medium of claim 51, further comprising code for reporting, to the network entity, a highest ranked WLAN access point in accordance with performing the one or more measurements for the one or more WLAN access points.

59. An apparatus for wireless communications, comprising:
a memory; and
a processor coupled to the memory and configured to:
transmit, from a user equipment (UE), a UE capability message and a reporting message to a network entity, wherein the UE capability message indicates whether the UE is capable of communicating over an unlicensed spectrum and the reporting message indicates whether the UE supports Wide Local Area Network (WLAN) measurements;
receive a measurement configuration message including a measurement configuration identifier, wherein the measurement configuration message triggers the UE to perform measurements for one or more WLAN access points based on the measurement configuration identifier; and
perform one or more measurements for the one or more WLAN access points based on the measurement configuration trigger and in accordance with receiving the measurement configuration message.

60. The apparatus of claim 59, wherein the measurement configuration message triggers the UE to perform measurements for each WLAN access point within a geographic area of the UE corresponding to the measurement configuration identifier.

61. The apparatus of claim 59, wherein the measurement configuration message triggers the UE to perform measurements for each WLAN access point over the unlicensed spectrum corresponding to the measurement configuration identifier.

62. The apparatus of claim 59, wherein the measurement configuration message triggers the UE to perform measurements for a subset of WLAN access points of the one or more access points within a geographic area of the UE corresponding to the measurement configuration identifier.

63. The apparatus of claim 59, wherein the measurement configuration message triggers the UE to perform WLAN measurements for each WLAN access point corresponding to the measurement configuration identifier.

64. The apparatus of claim 59, wherein the processor is further configured to receive a measurement purpose message either separately or with the measurement configuration message, wherein the measurement purpose message indicates that the measurements are not to be used for Long Term Evolution (LTE) WLAN Aggregation or Interworking.

65. The apparatus of claim 59, wherein the measurement configuration message triggers the UE to perform measurements for the one or more WLAN access points without including the measurement configuration identifier.

66. The apparatus of claim 59, wherein the processor is further configured to report, to the network entity, a highest ranked WLAN access point in accordance with performing the one or more measurements for the one or more WLAN access points.
